(19) United States
(12) Patent Application Publication
(10) Pub. No.: US 2024/0241524 A1
(43) Pub. Date: Jul. 18, 2024

(54) MINING OPERATION

(71) Applicant: TECHNOLOGICAL RESOURCES PTY LIMITED, Melbourne (AU)

(72) Inventors: Florian Andreas Oppolzer, Melbourne (AU); Peter Siew Hun Mah, Melbourne (AU); Anne Kathryn Brown, Melbourne (AU)

(21) Appl. No.: 18/585,153

(22) Filed: Feb. 23, 2024

Related U.S. Application Data
(63) Continuation of application No. PCT/AU2022/051032, filed on Aug. 25, 2022.

(30) Foreign Application Priority Data
Aug. 25, 2021 (AU) 2021221760
Aug. 25, 2021 (AU) 2021221812
Aug. 25, 2021 (AU) 2021221826
Aug. 25, 2021 (AU) 2021221840

(51) Int. Cl. G05D 1/667; E02F 9/20; E02F 9/26; G05D 1/692; G05D 105/05

(52) U.S. Cl. CPC G05D 1/667; E02F 9/2054; E02F 9/261; G05D 1/692; G05D 2105/05

(57) ABSTRACT

Methods and systems for efficiently operating haulers of varying sizes for transporting mined material at a mine site. The haulers can include “right-sized haul trucks (RSATs)”. Methods and systems for efficiently using containers for mined material, including loading, handling and transporting mined material within a mine or from a mine. The containers can be carried on haulers such as “movable units” and “moving units”.

### CROSS-REFERENCE TO RELATED APPLICATIONS

This application is a by-pass continuation of International PCT Application PCT/AU2022/051032, having an international filing date of Aug. 25, 2022, which claims priority to Australian Applications 2021221760, 2021221812, 2021221826 and 2021221840, all filed Aug. 25, 2021. Benefit of the filing date of each of these prior applications is hereby claimed. Each of these applications is hereby incorporated by reference in its entirety.

The present application is also related to the following co-pending international patent applications, each of which was filed on Aug. 25, 2022: PCT/AU2022/051026 (WO 2023/023798 A1); PCT/AU2022/051017 (WO 2023/023789 A1); and PCT/AU2022/051018 (WO 2023/023790 A1). Each of these applications is hereby incorporated by reference in its entirety.

### TECHNICAL FIELD

The invention relates to a mining operation that removes material from an area being mined in a mine and transports at least part of the mined material from the mine to another location in or outside the mine.

### BACKGROUND ART

In general terms, a mining operation removes material from an area being mined in a mine and transports at least part of the mined material from the mine to another location in or outside the mine. That other location may be a port. The mining operation may include processing a part of the mined material in a processing plant at the mine to upgrade the material.

Typically, a mining operation involves (a) loading and transporting loads of material (a) within different sections of a mine, (b) from a mine to a shipping port, and (c) at a shipping location (i.e. a customer plant), often with off-loading of loads from a transportation option onto stockpiles and loading stockpiled material onto the same or other transportation options.

The term “mine” includes an area that is being mined in a surface mine, such as an open cut mine, or an underground mine and stockpiles and size separation plants and processing plants (including for example comminution units and mineral recovery units associated with the mine).

The mine may be a mine that is at any phase in its life from a start-up phase through to an end of life phase, i.e. moving towards a shutdown.

The term “material” includes mined material and processed material.

The term “mined material” is defined further below.

The term “processed mined material” includes mined material that has been processed to an extent, for example by being sorted on the basis of size or the concentration of an element, whether the processing be wet or dry processing of material.

The term “mined material” includes as-mined material and may include as-mined material that has been at least primary crushed in open cut and underground mines.

The term “mined material” includes material in a mine as a result of drilling and blasting in a surface mine, such as an open cut mine, and material produced as a continuous miner moves over a mine floor and digs material from the floor in an open cut mine.

The term “mined material” includes material mined in underground mines, such as from block cave mines or by longwall miners, etc.

Mined material that is economic to process at the time it is mined is described herein as “ore” and mined material that is not economic to process at the time it is mined is described herein as “waste material”.

Mined material as described herein includes material that has been mined and processed to an extent, such as at least primary crushed in a pit of an open cut mine or in an underground mine, as the term “primary crushed” is understood in different sectors (e.g. iron ore, copper, etc) of the mining industry. Typically, primary crushed refers to the first crushing operation on a mined material. The extent of the crushing will vary depending on the type of mined material and the downstream requirements for the material.

Mined material as described herein may be metalliferous or non-metalliferous or metalloid material. Iron-containing and copper-containing ores are examples of metalliferous materials. Coal is an example of a non-metalliferous material.

Mined material is typically transported from an area being mined, whether that be a surface mine, such as an open-cut mine, or underground mine, for processing within the mine. Processing options include size separation plants and processing in mineral processing plants that upgrade the material for example via comminution and mineral recovery units. The mined material is often stored in stockpiles before being processed such as in mineral processing plants. Mined material is often transported with minimal processing (for example, size separation only) from a mine to a transport terminal, such as a shipping port. Typically, mined material is stored in stockpiles at shipping ports, particularly in the case of iron ore that may need to be blended to meet customer specifications. Mined material that is low grade (i.e. has a concentration of a selected element, whether that is measured directly or indirectly, below a selected concentration form the viewpoint of having sufficient economic value at that time) is often stored in stockpiles with a view to reclaiming the mined material at a future date when the mined material is regarded as having economic value and therefore being marketable.

There are issues storing mined material and processed mined material in stockpiles. These issues include loss of material in the process of transporting mined material and processed mined material to stockpiles and then from stockpiles and loss of material in the stockpiles due to wind and other environmental factors. These issues also include dilution of material due to mixing and material flow and hence loss of accurate information on material properties.

The invention provides an alternative mining operation.

The above description is not an admission of the common general knowledge in Australia or elsewhere.

### SUMMARY OF THE DISCLOSURE

The term “material handling unit” refers to any vehicle or machine that handles mined material and includes “material transport units” such as “haulers” and “loaders”.

The term “hauler” refers to any vehicle or machine that transports mined material within or from a mine site.

Haulers include “movable units” and “moving units”.

A “movable unit” is a vehicle that transports mined material in which the transportation of mined material is not limited to a particular path. Examples of “movable unit” include rear-tipping haul trucks and flat-bed haulage trucks.

A “moving unit” is machine that transports mined material in which the transportation of mined material is limited to movement along a particular path. Examples of “moving unit” include conveyors, lifts and trains. The term “loader” or “loading device” refers to any machine or vehicle that picks-up mined material and/or loads mined material into a hauler. Examples of loaders include “loading vehicles” such as electric rope shovels, diesel or electric hydraulic excavators, bucket wheel excavators, dragline excavators, front-end loaders (bulldozers) and “conveyor loaders” that comprise a chute.

Loaders include excavators, front end loaders, dozers, face shovel; rope shovels; and conveyor surge loaders.

An aspect of the invention provides a method of transporting a mined material, comprising: determining that a first hauler is located at a material loading location of a mine; controlling a plurality of loaders to load mined material into the first hauler, wherein the plurality of loaders are controlled such as to load into the first hauler mined material of a first material category only, and implementing dynamic control to ensure only one loader is interacting with the first hauler at a time; in response to identifying that loading of the first hauler is complete, controlling the plurality of loaders to cease loading of the first hauler; and communicating an instruction to the first hauler to move to a determined first unloading location for unloading of the loaded mined material, wherein the first unloading location is determined, at least in part, according to the first material category of mined material loaded into the first hauler.

The method may comprise: determining that a second hauler is located at the material loading location of a mine during loading of the first hauler; controlling the plurality of loaders to load mined material into the second hauler, wherein the plurality of loaders are controlled such as to load into the second hauler mined material of a second material category only, said second material category being different to the first material category, and implementing dynamic control to ensure only one loader is interacting with the second hauler at a time, such that at least a portion of the loading of the first hauler by the plurality of loaders occurs during loading of the second hauler by the plurality of loaders. The method may also comprise: sensing material picked up by a particular loader to enable characterisation of picked up material to thereby assign a corresponding material category to the picked up material; and directing the particular loader to load either the particular one of the first hauler and second hauler associated with the same material category of the picked up material. The method may comprise: in response to identifying that loading of the second hauler is complete, controlling the plurality of loaders to cease loading of the second hauler; and communicating an instruction to the second hauler to move to a determined second unloading location for unloading of the loaded mined material, wherein the second unloading location is determined, at least in part, according to the second material category associated with the second hauler, wherein the second unloading location is distinct to the first unloading location. The second hauler may arrive at the material loading location after initiating loading of the mined material into the first hauler.

The first hauler may be a haulage truck.

Alternatively, the first hauler may comprise a container that is or can be demountably located on a “movable unit” or is or can be demountably coupled to a “moving unit”.

Completion of loading of the first hauler may be identified by determining that the first hauler is full.

Completion of loading of the first hauler may be identified by determining that loading of the first hauler is to end before the first hauler is full.

The first hauler may be returned to the material loading location after unloading the loaded mined material and subsequently loaded with mined material of a different material category to the first material category.

An aspect of the invention provides a mine coordination system for coordinating loading of mined material at a material loading location of a mine into haulers, the system comprising: a controller configured, in response to determining an arrival of a first hauler in a load-ready state at the material loading location, to: control one or more loaders, via a data communication, to load mined material into the first hauler, wherein the one or more loaders are controlled such as to load into the first hauler mined material of a first material category only, wherein when two or more loaders are controlled to load the first hauler, the controller implementing dynamic control to ensure only one loader is interacting with the first hauler at a time; identify that loading of the first hauler is complete; in response, control the plurality of loaders to cease loading of the first hauler; and communicate an instruction to cause the first hauler to move to a determined first unloading location for unloading of the loaded mined material, wherein the first unloading location is determined, at least in part, according to the first material category of mined material loaded into the first hauler.

The controller may be configured to: upon determining that a second hauler is located at the material loading location during loading of the first hauler: control the plurality of loaders to load mined material into the second hauler, wherein the plurality of loaders are controlled such as to load into the second hauler mined material of a second material category only, said second material category being different to the first material category, and implement dynamic control to ensure only one loader is interacting with the second hauler at a time, such that at least a portion of the loading of the first hauler by the plurality of loaders occurs during loading of the second hauler by the plurality of loaders. At least one loader may comprise a sensing device for sensing characteristics of material picked up by said loader to enable characterisation of picked up material, and the controller may be configured to: when controlling a particular loader of said at least one loader to load mined material into the first loader and second loader: determine a material category of a picked up load of material as corresponding to the first material category or the second material category; and direct the particular loader to load either the particular one of the first hauler and second hauler associated with the same material category of the picked up material. The controller may be configured to: identify that loading of the second hauler is complete; in response, control the plurality of loaders to cease loading of the second hauler; and communicate an instruction to cause the second hauler to move to a determined second unloading location for unloading of the loaded mined material, wherein the second unloading location is determined, at least in part, according to the second material category of mined material loaded into the second hauler, wherein the second unloading location is distinct to the first unloading location. The second hauler may arrive at the material loading location after the system initiates loading of the mined material into the first hauler.

The first hauler may be a haulage truck.

The first hauler may comprise a container that is or can be demountably located on a movable unit or is or can be demountably coupled to a moving unit.

Completion of loading of the first hauler may be identified by determining that the first hauler is full.

Completion of loading of the first hauler may be identified by determining that loading of the first hauler is to end before the first hauler is full.

The first hauler may be returned to the material loading location after unloading the loaded mined material and subsequently loaded with mined material of a different material category to the first material category.

An aspect of the invention provides a method of mining in a mine includes: mining an area in the mine; loading a mined material of a particular material category only into a container that is demountably located on a movable unit or demountably coupled to a moving unit, wherein said first material category defines at least one property of the mined material; tracking the material category of material loaded into the container such as to enable machine identification of said material category; transporting the loaded container from the mining area on the movable unit or the moving unit to a container storage facility in the mine; and removing the loaded container from the movable unit or the moving unit in the container storage facility and storing the loaded container in the facility. The container storage facility may comprise two or more storage areas, each associated with a different material category, and the loaded container may be transported to a particular one of the storage areas in dependence on its assigned material category.

An aspect of the invention provides a method of mining in a mine includes: mining an area in the mine; loading a mined material of a particular material category only into a container that is demountably located on a movable unit or demountably coupled to a moving unit, wherein said material category defines at least one property of the mined material; tracking the material category of material loaded into the container such as to enable machine identification of said material category; transporting the loaded container from the mining area on the movable unit or the moving unit to a mineral processing plant in the mine in dependence on the material category associated with the container; and removing the loaded container from the movable unit or the moving unit at the mineral processing plant and processing the material in the plant.

The method may comprise: controlling a container transport network such as to provide load-ready containers, as required, to the area in the mine, wherein the container transport network comprising a plurality of container transporters, wherein each container transporter is controllable to receive and move a selected container to a selected location and release the selected container at the selected location. The method may comprise: tracking one or more statuses for each of a plurality of containers, each configured for receiving and storing mined material, thereby enabling identification of a particular container as being one of load-ready or loaded, wherein a load-ready container is presently suited to be loaded with a mined material and a loaded container is presently loaded with a mined material.

Each container may comprise a machine-readable identifier for identifying the particular container, and, for a loaded container, the material category associated with the loaded material may be determinable by cross-referencing the machine-readable identifier to a record associated with the container.

The method may comprise: selecting a particular material category for loading into said container; controlling at least one controllable loader at the location to load said container with mined material of said particular material category only.

The loader may be selected from one or more of the group including: s front end loader, an excavator; a dozer; a face shovel; a rope shovel; and a conveyor surge loader.

An aspect of the invention provides a mine coordination system for coordinating loading of mined material at a material loading location of a mine into containers, comprising: a controller configured to: control loading of a mined material of a particular material category only into a container that is demountably located on a movable unit or demountably coupled to a moving unit, wherein said material category defines at least one property of the mined material; maintain a record of the material category loaded into the container such as to enable machine identification of said material category; control the movable unit or the moving unit to move the loaded container from the mining area on to a container storage facility in the mine for removal of the loaded container from the movable unit or the moving unit in the container storage facility to thereby store the loaded container in the facility. The container storage facility may comprise two or more storage areas, each associated with a different material category, and the loaded container may be transported to a particular one of the storage areas in dependence on its assigned material category.

An aspect of the invention provides a mine coordination system for coordinating loading of mined material at a material loading location of a mine into containers, comprising: a controller configured to: control loading of a mined material of a particular material category only into a container that is demountably located on a movable unit or demountably coupled to a moving unit, wherein said material category defines at least one property of the mined material; maintain a record of the material category loaded into the container such as to enable machine identification of said material category; control the movable unit or the moving unit to move the loaded container from the mining area on to a mineral processing plant in the mine in dependence on the material category associated with the container for removal of the loaded container from the movable unit or the moving unit at the mineral processing plant to thereby enable processing the material in the plant.

The controller may be configured to: control a container transport network such as to provide load-ready containers, as required, to the area in the mine, wherein the container transport network comprises a plurality of container transporters, wherein each container transporter is controllable to receive and move a selected container to a selected location and release the selected container at the selected location. The controller may be configured to: maintain a container database for storing one or more statuses for each of a plurality of containers, each configured for receiving and storing mined material, thereby enabling identification of a particular container as being one of load-ready or loaded, wherein a load-ready container is presently suited to be loaded with a mined material and a loaded container is presently loaded with a mined material.

Each container may comprise a machine-readable identifier for identifying the particular container, and, for a loaded container, the material category associated with the loaded material may be determinable by cross-referencing the machine-readable identifier to the record associated with the container.

The controller may be configured to: select a material category for loading into said container; control at least one controllable loader at the location to load said container with mined material of said selected material category only.

The loader may be selected from one or more of the group including: a front end loader; an excavator; a dozer; a face shovel; a rope shovel; and a conveyor surge loader.

An aspect of the invention provides a material transport system for a mine, wherein the mine comprises one or more mining areas in which material is mined and thereby made available for transport, the system comprising: a plurality of moveable containers configured for receiving and storing mined material, wherein each container is identifiable by the system; a container transport network comprising a plurality of container transporters, wherein each container transporter is controllable to receive and move a selected container to a selected location and release the selected container at the selected location; and a transport controller configured for data communication with each of the container transporters to thereby control the container transport network, wherein the transport controller is configured to: maintain a container database for storing one or more statuses for each container, thereby enabling the transport controller to identify a particular container as being one of load-ready or loaded, wherein a load-ready container is presently suited to be loaded with mined material and a loaded container is presently loaded with a mined material; control the container transport network such as to provide load-ready containers, as required, to the one or more mining areas; upon determining that a container at a particular mining area is ready for transport, change said container's status to loaded and control the container transport network to move said container to a selected onwards location, wherein the containers are loaded with material of a particular material category only, said material category defining at least one property of the mined material.

An aspect of the invention provides a mining system for a mine, wherein the mine comprises one or more mining areas in which material is mined and thereby made available for transport, the system comprising: a plurality of moveable containers configured for receiving and storing mined material, wherein each container is identifiable by the system; a container transport network comprising a plurality of container transporters, wherein each container transporter is controllable to receive and move a selected container to a selected location and release the selected container at the selected location; and a transport controller configured for data communication with each of the container transporters to thereby control the container transport network, wherein the transport controller is configured to: maintain a container database for storing one or more statuses for each container, thereby enabling the transport controller to identify a particular container as being one of load-ready or loaded, wherein a load-ready container is presently suited to be loaded with mined material and a loaded container is presently loaded with a mined material, control the container transport network such as to provide load-ready containers, as required, to the one or more mining areas, upon determining that a container at a particular mining area is ready for transport, change said container's status to loaded and control the container transport network to move said container to a selected onwards location, wherein the system further comprises one or more site controllers, each associated with a particular mining area, configured to upon determining the presence, at the location, of a load-ready container: select a particular material category for loading into said container; control at least one controllable loader at the location to load said container with mined material of said particular material category only; and upon determining that loading of the container is to end, communicate to the transport controller an indication that the container is loaded and provide its assigned material category to enable to transport controller to identify an associated unloading location to deliver the container, thereby indicating to the transport controller that the container is ready for transport.

An aspect of the invention provides a method of mining in a mine includes: mining an area in the mine; loading a mined material in the mining area into a first container that is demountably located on a movable unit or demountably coupled to a moving unit by controlling a plurality of loaders to load mined material into the first container including implementing dynamic control to ensure only one loader is interacting with the first container at a time; transporting the loaded first container from the mining area on the movable unit or the moving unit to a container storage facility in the mine or a mineral processing plant in the mine; and removing the loaded first container from the movable unit or the moving unit in the container storage facility and storing the loaded first container in the facility; or removing the loaded first container from the movable unit or the moving unit at the mineral processing plant and processing the material in the plant.

The plurality of loaders may be controlled such as to load into the first container mined material of a first material category only, said first material category defining at least one property of the mined material, and the method may comprise: determining that a second container is located at a mining area of a mine during loading of the first container; loading a mined material of a second material category only in the mining area into the second container that is demountably located on a movable unit or demountably coupled to a moving unit by controlling a plurality of loaders to load mined material into the second container including implementing dynamic control to ensure only one loader is interacting with the second container at a time; transporting the loaded second container from the mining area on the movable unit or the moving unit to a container storage facility in the mine or a mineral processing plant in the mine; and removing the loaded second container from the movable unit or the moving unit in the container storage facility and storing the loaded second container in the facility, wherein the second container is stored in a separate storage area of the facility to the first container in dependence on the respective material categories; or removing the loaded second container from the movable unit or the moving unit at the mineral processing plant and processing the material in the plant.

The method may comprise: sensing material picked up by a particular loader to enable characterisation of picked up material to thereby assign a corresponding material category to the picked up material; and directing the particular loader to load either the particular one of the first container and second container associated with the same material category of the picked up material.

The method may comprise delivering empty containers to the site for subsequent loading of mined material.

An aspect of the invention provides a mine coordination system for coordinating loading of mined material at a material loading location of a mine into containers, comprising: a controller configured to: control loading of a mined material in the mining area into a first container that is demountably located on a movable unit or demountably coupled to a moving unit by controlling a plurality of loaders to load mined material into the first container including implementing dynamic control to ensure only one loader is interacting with the first container at a time; and control the movable unit or the moving unit to transport the loaded first container from the mining area on to a container storage facility in the mine or a mineral processing plant in the mine, such that the loaded first container is removed from the movable unit or the moving unit in the container storage facility and stored in the facility; or the loaded first container is removed from the movable unit or the moving unit at the mineral processing plant and processing the material in the plant.

The plurality of loaders may be controlled such as to load into the first container mined material of a first material category only, and the controller may be configured to: determine that a second container is located at a mining area of a mine during loading of the first container; load a mined material of a second material category only in the mining area into the second container that is demountably located on a movable unit or demountably coupled to a moving unit by controlling a plurality of loaders to load mined material into the second container including implementing dynamic control to ensure only one loader is interacting with the second container at a time; control the movable unit or the moving unit to transport the loaded second container from the mining area on to a container storage facility in the mine or a mineral processing plant in the mine, such that the loaded second container is removed from the movable unit or the moving unit in the container storage facility and stored in the facility; or the loaded second container is removed from the movable unit or the moving unit at the mineral processing plant and processing the material in the plant.

At least one loader may comprise a sensing device for sensing characteristics of material picked up by said loader to enable characterisation of picked up material, and the controller may be configured to: when controlling said at least one loader to load mined material into the first container and second container: determine a material category of a picked-up load of material as corresponding to the first material category or the second material category; and direct the loader to load the corresponding first container or second container in dependence on the determined material category.

The controller may be configured to control delivery of empty containers to the site for subsequent loading of mined material.

An aspect of the invention provides a method of transporting a mined material, comprising: determining that a plurality of haulers are located at a material loading location of a mine, each hauler associated with a different material category of a set of material categories; controlling a plurality of loaders to load mined material into the haulers, wherein the loaders are configured to determine a material category of each load of mined material picked up at the material loading location, and wherein the loaders are controlled to load picked up material into the particular hauler associated with the same material category as determined to comprise the particular load, such that each hauler is only loaded with mined material of its associated material category, and implementing dynamic control to ensure only one loader is interacting with a particular hauler at a time; in response to identifying that loading of a particular hauler is complete, controlling loaders to cease loading of the identified particular hauler; and communicating an instruction to the identified particular hauler to move to a determined unloading location for unloading of the loaded mined material, wherein the unloading location is determined, at least in part, according to the material category of mined material loaded into the identified particular hauler.

An aspect of the invention provides a mine coordination system for coordinating loading of mined material at a material loading location of a mine into haulers, the system comprising a controller configured to: determine that a plurality of haulers is located at a material loading location of a mine, each hauler associated with a different material category of a set of material categories; control a plurality of loaders to load mined material into the haulers, wherein the loaders are configured to determine a material category of each load of mined material picked up at the material loading location, and wherein the loaders are controlled to load picked up material into the hauler associated with the same material category as determined for the particular load, such that each hauler is only loaded with mined material of its associated material category, and implementing dynamic control to ensure only one loader is interacting with a particular hauler at a time; in response to identifying that loading of a particular hauler is complete, control the one or more loaders to cease loading of the identified particular hauler; and communicate an instruction to the identified particular hauler to move to a determined unloading location for unloading of the loaded mined material, wherein the unloading location is determined, at least in part, according to the material category of mined material loaded into the identified particular hauler.

The mine may be a mine that is in a start-up phase.

The mine may be a mine that is in a fully-operational phase after a start-up phase has ended.

The mine may be a mine that is in an end of life phase.

### BRIEF DESCRIPTION OF THE DRAWINGS

Embodiments of the invention are described further below by way of example only with reference to the accompanying Figures, of which:

FIG. 1 is a schematic view of a typical open cut mine;

FIG. 2 is a is a schematic view of an open cut mine according to an embodiment of the invention;

FIG. 3 is a system diagram of a mining operation according to an embodiment of the invention;

FIG. 4 is a schematic view of a mine site on which one or more embodiments of the present invention may be practiced;

FIG. 5 is a schematic block diagram representation of a system that includes a general-purpose computer on which one or more embodiments of the present invention may be practiced;

FIG. 6 is a schematic view of material handling units, such as autonomous loading vehicles and autonomous haul trucks, in operation at a blasted bench of an open cut mine;

FIG. 6A is a schematic diagram of a prior art double side loading method;

FIG. 7-9 are side views of loading vehicle in the form of a front-end loader in different operational configurations;

FIG. 10 is a block diagram of a vehicle and sensing assembly of the machine of the material handling units;

FIG. 11 is a schematic view of a system comprising a vehicle coordination assembly, data network and loading vehicles and haul trucks in operation at a blasted bench;

FIG. 12 is a block diagram of a vehicle communications assembly;

FIG. 13 is a detail top plan view of loading vehicles and haul trucks in operation at a blasted bench;

FIG. 14 is a diagram depicting first and second loading vehicles implementing loading tasks assigned to them from the vehicle coordination assembly shown in FIG. 11 to load a load-ready haul truck from opposed sides thereof; and

FIG. 15 is a diagram depicting safe operational boundary boxes for the first and second loading vehicles of FIG. 14 for collision avoidance;

FIG. 16 is a block diagram of a material categorisation and transportation system according to an embodiment of the invention;

FIG. 17 is a schematic view of haul truck of FIG. 16;

FIG. 18 is a schematic view of a loading device and haul truck of the system of FIG. 16;

FIG. 19 is a schematic view of an alternate loading device of the system of FIG. 16;

FIG. 20 is a flow chart of the process of use of the system of FIG. 16;

FIG. 21 is a perspective view of a container for use in the mine shown in FIG. 2 with the container in a closed configuration;

FIG. 22 is a perspective view of a container for use in the mine shown in FIG. 2 with the container in an open configuration;

FIG. 23 is a schematic view of a “movable unit” in the form of a flatbed truck and the container shown in FIGS. 21 and 22 located on and being transported by the flatbed truck;

FIG. 24 is a schematic view of a “moving unit” in the form of an overhead suspension system, such as a ski lift type haulage system, and the container shown in FIGS. 21 and 22 suspended from and being transported by the overhead suspension system;

FIG. 25 is a schematic view of a “moving unit” in the form of a train with multiple flatbed rail carriages and a plurality of the container shown in FIGS. 22 and 23 located on the flatbed rail carriages and being transported by the train;

FIG. 26 is a schematic view illustrating a plurality of the container shown in FIGS. 21 and 22 stacked in an intermodal, such as a shipping port-like, storage and handling facility in accordance with an embodiment of the invention;

FIG. 27 is a top plan view of the intermodal storage and handling facility of FIG. 26.

### DESCRIPTION OF EMBODIMENTS

### Chapter I—Overview of Mining Operations

The following description focuses to an extent on surface mining in the form of open cut mining operations for iron ore.

The invention also extends to surface mining generally, including open cut mining operations, and to underground mining operations.

The invention is not limited to mining iron ore.

The description mentions mining operations for other materials, such as copper-containing materials, and processing steps that are relevant to these materials.

The invention extends to mining operations for other materials, such as by way of example only metalliferous materials containing copper, nickel, lithium, aluminium (such as bauxite and alumina), and cobalt, and non-metalliferous materials such as coal, and metalloid materials such as boron (such as borates).

Conventional open pit mining operations for iron ore comprise progressively drilling and blasting sections of an area to be mined and removing material in those sections from a mine. It is known to mine iron ore in large blocks using a series of benches so that various mining activities can be carried out concurrently in a pit. A bench, which may contain many thousands of tonnes of ore and/or other material is first drilled to form a pattern of “blast” holes. The blasted material is picked up by earth-moving vehicles in the form of front-end loaders and excavators (such as by way of example, electric rope shovels, diesel or electric hydraulic excavators, bucket wheel excavators, dragline excavators) and placed into haulage vehicles such as trucks and transported to a stockpile or to downstream processing plants to produce marketable products to customer specifications.

Downstream processing options in iron ore mines include (a) crushing and screening of mined material to different-sized specifications, such as lump and fines products and (b) more extensive processing in a mineral processing plant that upgrades the mined material. These upgrading processes may be wet or dry processes.

Typically, depending on scheduling requirements, option (a) material is either stored in a stockpile or is transported directly to a railhead (or other transportation option) and then by rail to a port for shipping to a market. Typically, the material is stockpiled at the port and blended with other mined material from the same or other mines and then loaded onto ships that transport the material to markets. Materials handling at ports tends to involve multiple, complex bulk handling steps for mined material.

It is noted that some conventional iron ore open pit mining operations use haul trucks as the only transportation option.

Generally, the sequence of stages of mine→stockpile (coarse ore)→crush/process→stockpile→transport→stockpile→ship in conventional iron ore open pit mining operations so that each stage “→” uses haul trucks, trains, ships or a mixture of these options.

Typically, operations in a mineral processing plant in option (b) in an iron ore mine (and in mining operations generally, and not confined to iron ore) involve: (i) coarse comminution (crushing and screening); (ii) fine comminution (grinding); and (iii) recovery stages (e.g. flotation, leaching).

The term “comminution” as used herein describes processes which reduce the particle size of rocks by, first, crushing (most often in combination with screening or other size separation) and, secondly, grinding (in combination with screening or other size separation).

A recovery stage that applies to a range of mining operations, iron ore, copper-containing material, etc. refers to processes where: (a) valuable minerals are separated from non-valuable material; and/or (b) valuable metal (where metal is a target element) is extracted from the minerals; and/or (c) valuable minerals are separated from other neighbouring valuable minerals. Recovery stage techniques are typically used in combination. A recovery stage technique is usually classified as either wet (using water as a significant part of the process) or dry (largely in the absence of water). Some examples of recovery stage techniques are leaching (wet recovery); flotation (wet recovery); gravity concentration, also referred to as gravity separation (wet recovery); magnetic separation (wet or dry recovery); and particle sorting (dry recovery).

Conventional vehicles for moving mined material include large haul trucks (such as “ultra-class” haul trucks) for open cut and other surface mines and load, haul, dump (LHD) vehicles for underground mines.

Mined material can also be transported via a conveyor, for example via in-pit crushing and conveying (IPCC) systems.

All of the above types of vehicles, conveyors, etc are described generally herein as “material transport units”. Chapter VI of the specification also refers to “movable unit” and “moving unit”.

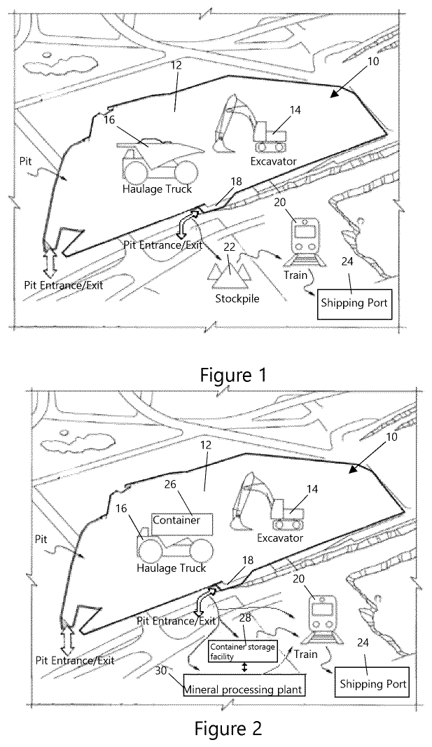

FIG. 1 shows a schematic view of a typical open cut mine 10 and mining method. The mine 10 comprises a pit 12 that extends below ground level. Inside the pit 12 front end loaders or excavators 14 (or any other suitable earth moving vehicles) dig material that is in the pit 12 after being blasted from benches (not shown) and loads the material into trays of conventional rear-tipping haul trucks 16. The haul trucks 16 transport the mined material from the pit 12 along haul roads 18 to an exit point at ground level. Typically, the haul trucks 16 have rear-tipping trays and are large vehicles capable of transporting large payloads of in excess of 200 tonnes.

At ground level, depending on mine scheduling, the haul trucks 16 transport the material along roads to:
(a) a railway 20 where the material is dumped into rail cars, or
(b) a stockpile where the material is dumped into open-air stockpiles 22.

The haul trucks 16 then travel back to the pit 12 to repeat the cycle.

As required, stockpiled material is loaded onto a conveyor (not shown) or a different haul truck (not shown) and transported from the stockpiles 22 to:
(i) the railway 20 and dumped into rail cars, or
(ii) a mineral processing plant (not shown) that includes comminution units and mineral processing units for upgrading the material.

The railway 20 (option (a) or (i)) transports the material to a shipping port 24 where the material can be further processed, for example, blended and then shipped to overseas markets.

Alternatively, the mined material is discharged from the haul trucks 16 at the mineral processing plant and processed in the plant (option (ii)). The haul trucks 16 return to the pit 12. The processed material is transported to the shipping port 24 and can be further processed before being shipped to overseas markets.

An embodiment of the shipping port 24 is described in Chapter IV of the detailed description.

FIG. 2 shows a schematic view of an embodiment of an open cut mine 10 according to the present invention.

The mine of FIG. 2 operates to an extent in the same way as the mine of FIG. 1, where like reference numbers represent the same elements, noting that as well as similarities there are also significant differences between the mines and mining methods in the mines.

The mining operation. i.e. the mine and mining method of FIG. 2, differs from the mine and mining method of FIG. 1 in the way in which mined material is transported from the pit 12 and within and from the mine.

With reference to FIG. 2, in the pit 12, mined material is loaded into a container 26 by a loader/excavator/shovel, etc. 14 at a dig face of a blast site and the container is closed once it reaches a payload limit.

The container 26 may have a form factor that is similar or identical to intermodal containers (i.e. shipping containers). The container 26 is configured to transport mined material within a mine and from a mine in fixed, discrete load units; namely a “container load”. The container 26 is mountable onto and dismountable from “movable units” and “moving units” for transportation within the mine or from the mine. As is described further below, the container 26 may be (a) unloaded and stacked at designated stockpile locations or (b) discharged directly into comminution units of mineral processing plants or (c) loaded onto other transport options, such as rail transport and taken to other locations such as shipping ports or (d) otherwise processed.

The container 26 may be any suitable size.

For example, the container 26 may be capable of containing a payload of at least 10 tonnes and up to a maximum of 80 tonnes or more, typically 10-80 tonnes, with options of 30-70 tonnes, and 40-60 tonnes, and the container is closed once it reaches a payload limit. The payload limit may be reached when the container is full or when it is decided that no more material should go into the container, for example when a change in a grade or certain mineral characteristic of the mined material is detected and it is not desired to have mined material of mixed grades or mineral characteristics in the one container. An embodiment of the container 26 is described in Chapter VI of the detailed description.

It is emphasised that the invention is not confined to the use of such containers 26.

It is also important to note that, as is described further below, the mining operation of the invention includes controlling movement of material transport units in and from a mine and how such material transport units are loaded in the mine by loading units.

### Chapter II—RSATs

This chapter outlines advantages that material transport units in the form of right-sized haul trucks (“RSATs”) have over other material transport units in the form of ultra-class haul trucks. This chapter also outlines disadvantages of operating right-sized haul trucks and presents a number of solutions to ameliorate these disadvantages.

### Ultra-Class Haul Trucks

The conventional thinking in the mining industry is bigger is always better—which has led to ultra-class haul trucks being widely adopted throughout the industry. Ultra-class haul trucks have a very high payload capacity, of between 300 and 400 tonnes, and can thus provide the required economy of scale in mining operations. Some examples of ultra-class haul trucks include the Komatsu 980E-4 haulage trucks which have a 369 tonne payload capacity and the Caterpillar 797 haulage trucks which have a 364 tonne payload capacity. However, these ultra-class haul trucks have a number of disadvantages.

Firstly, ultra-class haul trucks are expensive; they cost around $3-$6 million each. Ultra-class haul trucks are, unconventional by nature, and therefore require specialised materials and skill to operate and maintain. For example, a single tire costs more than $35,000. Ultra-class haul trucks are manufactured in very low numbers and are generally custom ordered; involving significant lead times and capital expense. Consequently, it is difficult to adjust the size of fleets of mining equipment in response to changes in mining conditions, as ordering and commissioning new machinery takes a long time and requires advance budget planning. Consideration must also be given to the time and costs to recruit and train personnel to operate and maintain any increases in the number of haul trucks. Given the capital cost associated with such haul trucks, it is important that those haul trucks are in operation as much as possible.

Secondly, ultra-class haul trucks are, by their nature, extremely very large vehicles. Their size is roughly equivalent to a two-story house: a height of about 8 metres; a width of about 10 metres; a length of about 15 metres; an empty weight of about 200-300 tonnes; and a fully laden weight of around 650 tonnes. Due to their massive size, these vehicles are slow moving—having a top speed of around 60 km/hr and are difficult to maneuver—they have a large turning radius, around 15-30 metres. Ultra-class haul trucks consume vast quantities of fuel (typically 40-80 litres an hour while idle) and have a limited range (around 20 km to 30 km) before they need to stop due to their tyres overheating. Due to this limitation, it is necessary for ultra-class haul trucks to dump the carried material in stockpiles close to the mine. To move mined material further than 30 km, excavators pick up the dumped material from the stockpile and load it into another ultra-class haul truck that will transport the material to the destination point. It will be appreciated that this rehandling of material, i.e. the dumping and reloading of material from one haul truck onto the ground and then onto another haul truck, is inefficient.

Thirdly, their size dictates the size of the infrastructure of the mine. Mine roads need to be wide enough to accommodate the ultra-class haul trucks, i.e. at least 15 metres wide to operate safely in a single direction (a one-lane road), and consequently ultra-class haul trucks may require roads of at least around 30 to 40 metres wide to enable trucks travelling in opposite directions (a two-lane road), to pass safely. In addition, ultra-class haul vehicles can only safely travel along roads with gradients of less than 10% (in other words a 1 in 10 gradient, i.e. 1 m in vertical distance over 10 metres in horizontal distance) and preferably less than 7% (in other words a 1 in 15 gradient, i.e. 1 m in vertical distance over 15 metres in horizontal distance) to minimise wear and tear on the engines. As such, over a particular distance in elevation in the pit, the roads need to be at least ten times longer than this distance in order to satisfy the maximum allowable gradient. Mines typically include a plurality of areas to be blasted. Each area that is to be blasted is called a bench. Benches are generally level, horizontal areas. For large mines, benches are may be in the range of 10 to 15 metres in height; greater than 70 metres in width; and many hundreds of metres in length. The bench size may be any size. Mining may be conducted contemporaneously on a number of benches within a mine, with different benches and other areas of the mine connected by a series of roads and ramps. Such shallow gradients result in roads that are long and wide, which influences the size and shapes of benches that can be blasted within a mine site. Long, wide roads also require more excavation and construction to prepare and result in longer travel times. As such, to produce infrastructure of this magnitude, long lead times are required, and costs are significant. In addition, due to the weight of the trucks, mine roads are typically left unsealed which may contribute to the amount of dust and particulate matter in the air and which often needs to be suppressed. Unsealed roads become slippery when exposed to rainfall, particularly the ramps within a mine site. Consequently, unsealed roads may be taken out of use when slippery, halting mining operations.

Fourthly, the use of ultra-class haul trucks has an impact on the strip ratio of the mine. The strip ratio of a mine is a measurement of the amount of waste (also commonly referred to as overburden) that must be removed from a mine site to obtain a given ore quantity. The strip ratio is a direct indication of how much waste material is mined per unit of ore. Wide roads with shallow gradients result in a high strip ratio, requiring a large amount of waste material to be extracted for a given quantity of valuable ore.

### Right-Sized Haul Trucks

Right-sized haul trucks are trucks that are capable of being used on sealed roads, such as public roads. These trucks typically have a payload capacity in the range of 10 to 80 tonnes, suitably 40 to 60 tonnes. The use of right-sized haul trucks in the place of ultra-class haul trucks is a paradigm shift in the mining industry and presents a number of advantages.

Firstly, they are cheaper to purchase, operate, and maintain than ultra-class haul trucks. The purchase cost of right-sized haul trucks is considerably less than the large capital expenditure associated with ultra-class haul trucks. Consequently, fleet sizes of right-sized haul trucks can be changed relatively quickly, enabling mining operations to adapt to changing demands, such as increased or decreased output.

Taking one right-sized haul trucks offline to service, out of a large fleet of right-sized haul trucks, has less impact on the overall mining operation than taking one ultra-class haul truck offline to service, out of a small fleet of ultra-class haul trucks. Servicing of right-sized haul trucks is often able to be performed by auto mechanics with a standard level of skill, rather than the specialist skills required to maintain ultra-class haul trucks. Spare parts are more readily available, both in terms of quantity and the ability to be transported.

Secondly, the flexibility associated with right-sized haul rucks provides opportunities not presently available through the use of ultra-class haul trucks. Right-sized haul trucks can utilise public roads which improves accessibility. Right-sized haul trucks can utilise conventional infrastructure and may not need customised infrastructure (e.g. maintenance bays and re-fuelling facilities). Right-sized haul trucks are smaller than ultra-class haul trucks and therefore do not share the same degree and scale of infrastructure required for ultra-class haul trucks. Right-sized haul trucks can use narrower roads, e.g. between 3 and 12 metres wide, and negotiate steeper gradients, e.g. greater than 10% (1 in 10) gradients, suitably between 10% (1 in 10) and 20% (1 in 5) gradient, suitably between 10% (1 in 10) and 14% (1 in 7). A direct consequence of narrower and steeper roads is that smaller benches can be used, in the range of 2.5 to 15 metres in height and 20 to 70 metres in width. This reduces the lead time and costs associated with producing the mine infrastructure.

Using narrow roads also makes it more cost effective to seal some or all of the access roads approaching and within a mine site, which obviates the need to wet and grade roads, as is presently required for the unsealed roads. Sealed roads require less regular maintenance and produce less dust/airborne particulate matter. Right-sized haul trucks travelling on sealed roads are able to travel greater distances than ultra-class trucks—they are not limited to a maximum range of 20 km to 30 km. As a consequence, mine infrastructure, such as crushers or railheads, may be located further from the mine floor. Further, right-sized haul trucks can use more of the road surface, as ultra-class haul trucks place huge stress on road edges.

Right-sized haul trucks are typically faster than ultra-class haul trucks; with a top speed of around 80 km/hr to 100 km/hr as opposed to a top speed of 60 km/hr. Whilst right-sized haul trucks cannot carry loads as large as ultra-class haul trucks, the right-sized haul trucks can be loaded and unloaded more quickly and can move from one point to another more quickly than ultra-class haul trucks.

Thirdly, the use of right-sized haul trucks increases the precision and resolution of mining operations. A surprising consequence of using right-sized haul trucks is that blast models can be denser, yielding tighter fragmentation. Consequently, using right-sized haul trucks can improve the strip ratio, with less overburden mined to obtain a quantum of ore. This is because wide roads create a shallow final wall angle, so it is necessary to cut back further to reach/uncover a desired region of material. The steeper the average slope is, the less dirt (i.e. overburden) that needs to be dug out. The average wall angle includes roads and the bench to bench wall slope. Steeper ramps create overall shorter roads to get to a certain depth within a mine site. Thus, the width of the roads, the size of the benches, and the gradient of the ramps all impact the strip ratio for a given mine site or portion of a mine site. Narrower roads with steeper ramps produce a lower strip ratio. Further, adopting a smaller bench height design (i.e. height less than 10 m) allows for better moulding of the mine along the ore body than using typical benches (i.e. height greater than 10 m).

Benches may be designed based on an identified area of interest within a mine. The area of interest may be identified through one or more of a geological model of the mine; measurement while drilling (MWD) data from existing operations within the mine; exploratory drillings within the mine; and scanning of the mine.

Once the area of interest has been identified, a bench may be designed to be optimised for efficiency of retrieval of material from that area. The design may include one or more of size and location of the bench, and the size and location of at least one ramp to access the bench. The size of the bench may include, for example, one or more of the height, width, and length of the bench. The size and location of each ramp may include, for example, one or more of the length, gradient, and width of the respective ramp, as well as the start and end positions of the ramp. Such methods enable the design of benches within a mine to target specific ore deposits, such as particularly high grade ore deposits.

Design of a bench may also include dimensions of the blocks to be produced by blasting the bench. Such block sizes may have a volume of less than 1000 m3 (e.g. 10 m×10 m×10 m). Dimensions of suitable block sizes may include, for example, 5 m×5 m×5 m (having a volume of 125 m3) or 2.5 m×2.5 m×2.5 m (having a volume of about 16 m3). Further, design of the bench may also include blast design parameters. Blast design parameters may include, for example, the number of blast holes, the location of the blast holes, the diameter of the blast holes, the depth of the blast holes, the type of explosive to be used, and the volume of explosive to be used in each of the blast holes.

A stockpile may be taken into consideration when designing benches. In this regard, an area of interest is identified, a bench is designed to be optimised for efficiency of retrieval of material from that area, the bench is blasted, and then the blasted material is retrieved and optionally stored in a stockpile. As a stockpile is used, multiple areas of interest within a mine may be identified and mined in the above described manner. This is a form of more targeted mining, in which smaller benches are designed for specific areas of interest to extract material from particular ore sites, in contrast to traditional mining in which a whole mine site is blasted to extract material, which yields comparatively poor yield ratios. Smaller block sizes allow for greater selectively and less dilution, as it would not be as uneconomical to load a smaller truck with predominantly one grade, even if only partially filled.

Each load of an ultra-class haul truck represents a significant load, both in terms of the volume of the carrying capacity of the haulage truck and the time taken to load and transport that load. Consequently, such ultra-class haul trucks are loaded to maximum capacity for each run with whatever material has been blasted and sorting and processing of the blasted material occurs downstream.

Right-sized haul trucks have a much smaller carrying capacity. Consequently, a fleet of right-sized haul trucks can be utilised to transport different types of blasted material, based on size, composition, or a combination thereof.

As right-sized haul trucks have significantly less payload capacity than ultra-class haul trucks, there is less dilution or mixing of mining materials having different grades or properties in each load of a right-sized haul truck. That is, each load in a right-sized haul truck is more homogenous than a load from a large capacity ultra-class haul truck.

Right-sized haul trucks can be designated different roles, such that a first set of trucks is loaded with blasted material having a higher ore content and a second set of trucks is loaded with blasted material having a higher waste content.

Sorting blast material at the blast site provides further improvements in this regard. Loading of a truck can stop when a change in composition of the material to be loaded is detected, so that waste material can be re-directed to another truck. This avoids dilution of the current payload of the truck. Further, as right-sized haul trucks have smaller carrying capacities, there is less penalty to send trucks without being fully loading the truck each time as would be the case for ultra-class haul trucks which would be uneconomical to partially load.

A mine site with a fleet of right-sized haul trucks can be worked in conjunction with more targeted blast sites which produce small fragments of blast material.

A mine site operating with a fleet of right-sized haul trucks can utilise a set of mobile crushers to crush larger blast material into a size suitable for loading into the right-sized haul trucks. Crushing material at the blast site into smaller fragments again provides greater insight into the composition of the blasted material. Information about the mine and its contents are more granular (i.e., providing a higher resolution of the content of the mine) at an earlier time in the mining process, which enables a mine operator to make more informed decisions about the composition of that mine and the mine operator is able to mine more selectively.

Small fragments of blast material may be suitable to be collected and moved using small front-end loaders. Small front-end loaders are manoeuvrable and are well suited to loading right-sized haulage trucks. The small fragments of blast material are more readily examined to determine the composition of that blast material.

In contrast, a conventional mine site typically has blast sites that extend over a large area and produce fragments of blast material of a size that require excavators to move. Such excavators are relatively static and utilise large swing arms to collect and move material.

It is envisaged that a mine site that utilises a fleet or one or more right-sized haul trucks, each truck having a payload in the range of 10 tonnes to 80 tonnes, and preferably in the range of 40 tonnes to 60 tonnes can achieve a total daily material throughput of approximately 50,000 tonnes to 500,000 tonnes.

Right-sized haul trucks in the range of 10 tonnes to 80 tonnes or less are well suited to being powered using electric motors, in contrast to internal combustion engines, or with hybrid engines that combine one or more electric motors with an internal combustion engine. The use of electric haulage trucks and other autonomous material handling units reduces carbon emissions.

Each right-sized haul truck can have a maximum payload capacity corresponding to a predefined percentage of a predefined average daily material throughput over a month. In some embodiments, the predefined percentage is in the range of 0.01% to 0.05%, and preferably in the range of 0.015% to 0.035%.

However, even with the above advantages, it will be appreciated that, based on conventional thinking, using right-sized haul trucks instead of much larger ultra-class haul trucks would not be considered given the significant decrease in per truck, per journey capacity. Further, the use of a greater number of right-sized haul trucks to offset the above size constraints would also not fall in line with conventional thinking as this would result in a perceived increase in labour costs due to an increase in the total number of vehicles potentially requiring a greater number of drivers or supervisory personnel, greater road traffic that will be an issue on mine sites where road space is limited, increased wear on roads and increased potential for traffic issues, such as congestion, conflicts and collisions.

### Autonomous Right-Sized Haul Trucks (RSATs)

Automation can ameliorate some of the issues associated with controlling large fleets of right-sized haul trucks.

Autonomous right-sized haul trucks (RSATs) are driverless or computer augmented right-sized haul trucks. RSATs operate without or with very little human intervention. The RSATs can be remotely controlled from a control center that is located at the mine or is remote from the mine. The RSATs may have sensors and onboard processing capability such that they can make certain decisions about the environment without human intervention or input from the control center. For example, RSATs may have a collision avoidance system to prevent collisions.

The term “RSAT” as described herein means a conventionally-sized, autonomous, and preferably although not exclusively electric, movable vehicle, such as a truck, that is configured to receive and support a container holding mined material.

The term “conventionally-sized” as used herein describes trucks that are around or within the conventional size range of movable vehicles, such as trucks, that can travel on public roads.

The chapters that follow will discuss in detail aspects relating to the control of autonomous right-sized haul trucks. Specifically, control of autonomous vehicles at a mine site (Chapter III) and coordinating loading of haul trucks (Chapter IV).

The term “autonomous trucks” refers to vehicles that are preconfigured to autonomously travel along a predefined route between one or more locations, generally not deviating from that predefined route. It is important to note that the term “autonomous” will be known by those skilled in the art as being distinct from the term “automatic”, in that an “autonomous” vehicle is capable of making certain decisions for itself based on sensed inputs, whereas an “automatic” vehicle merely acts according to a predefined script. More specifically, an “automatic” vehicle generally requires constant human monitoring in order to deal with exception conditions, whereas an “autonomous” vehicle is able to respond to a number of exception conditions without human intervention. Further, an “autonomous” vehicle is able to actually identify and differentiate circumstances where human intervention is required (and send the appropriate alert and take action to safely continue with other actions or safely switch to an idle state) from those where human intervention is not required (and the above noted decision making capabilities are utilised).

### SUMMARY

The use of RSATs and other conventionally-sized vehicles in the context of a mine can assist in realising the following advantages:

Firstly, roads can be used in and around the mine which are narrower and steeper than the roadways suitable for ultra-class trucks. Narrow and/or steep roads require less time to develop as less ground (e.g. overburden) needs to be excavated in the development process. This leads to an increase in the strip ratio of the mine because less overburden is required to be excavated to produce the roads. Roads can be sealed and are therefore easier to maintain. Scaled roads result in fewer dust and air borne particulate matter that might otherwise need to be suppressed. Sealed roads also provide a smoother ride which may contribute to extending the interval between necessary vehicle maintenance and improvement in vehicle safety.

Second, RSATs and other conventionally-sized vehicles are an opportunity to mine comparatively small volumes of valuable minerals that would otherwise be uneconomical to mine with ultra-class trucks and associated large scale excavators.

Third, RSATs and other conventionally-sized vehicles are typically cheaper to purchase, operate and maintain than ultra-class trucks, even though more vehicles are required to transport the same payload. They required less specialised engineering skills to maintain the vehicles compared to ultra-class trucks. RSATs have an improved range over ultra-class trucks which leads to a reduction in double handling. Typically, ultra-class trucks have a limited travel range when loaded and can only travel a short distance from the mine before dumping their load in an open pile—the dumped load is then reloaded onto other trucks to be transported further from the mine.

Fourthly, some RSATs and other conventionally-sized vehicles have a chassis size that makes them suitable to carry standard intermodal type containers, i.e. 20 ft or 40 ft shipping containers. Some of the many advantages of these types of containers are elaborated on Chapter VI.

### Chapter III—Control of Autonomous Vehicles at a Mine Site

This chapter outlines an embodiment in which any number of autonomous vehicles are centrally controlled remotely from or at a mine site.

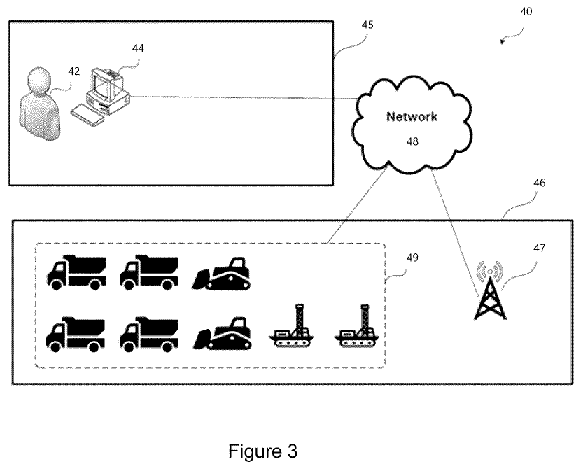

In the example of FIG. 3, the mining operation relates to a mine site 46 that is serviced by a fleet of autonomous material handling units 49. The system 40 includes a remote-control centre 45 for remotely operating control of the fleet of autonomous material handling units 49. The control centre 45 may be co-located with the mine site 46 or located remotely from the mine site 46. In the example of FIG. 3, the control centre 45 is located remotely from the mine site 46 and is in communication with the mine site via a communications network 48.

The remote-control centre 45 includes a control station 44 that is accessed by a human controller 42 to monitor and control operation of the fleet of autonomous material handling units 49 at the mine site 46. Whilst the autonomous material handling units 49 are configured to operate autonomously, the control station 45 provides the human controller 42 to intervene with manual override of one or more controls associated with one or more of the autonomous material handling units 49 or to change settings in a control program that sends commands to control operation of the autonomous material handling units 49. Whilst the example of FIG. 3 shows a single control station 45, other embodiments may include control stations to allow contemporaneous access by multiple human controllers. In a large installation, different controllers utilise a set of control stations to monitor an allocated set of autonomous material handling units 49 across one or more mine sites.

The control station 45 is coupled to the communications network 48. The communications network 48 may be implemented utilising one or more wired communications links, wireless communications links, or any combination thereof. In particular, the communications network 48 may include a local area network (LAN), a wide area network (WAN), a telecommunications network, or any combination thereof. A telecommunications network may include, but is not limited to, a telephony network, such as a Public Switch Telephony Network (PSTN) or a cellular mobile telephony network, the Internet, or any combination thereof.

Each of the autonomous material handling units 49 in the fleet is equipped with a wireless transceiver for coupling the respective autonomous material handling unit with the communications network 48. Each autonomous material handling unit 49 may be coupled directly to the communications network 48 or via a network of one or more transmission towers 47 located at the mine site. In the example of FIG. 3, the fleet of autonomous material handling units 49 includes a combination of drill rigs, loaders (bulldozers), and haul trucks. Other material handling units may equally be practised.

During operation, the control station 45 and autonomous material handling units 49 communicate with each other via the communications network 48. Each autonomous material handling unit is equipped with a geolocation device, such as a Global Positioning System (GPS) locator, so that the co-ordinates of each unit are known at any moment. The material handling units 49 are able to send information back to the control station 44 at the remote-control centre 45, such as information about the location, speed and orientation of the respective material handling unit, as well as operating parameters, such as temperature, fluid levels, and the like.

Each autonomous material handling unit 49 includes an onboard controller that is configured to control operation of that material handling unit. Such onboard controllers are implemented using a computing device and operations may include, for example, but are not limited to, the ability to turn the unit on and off, the ability to operate the unit in accordance with a received map or program, such as to steer or navigate along a programmed path.

In some embodiments, one or more of the autonomous material handling units 49 is equipped with proximity sensors that detect the presence of an object within a predefined distance or range of the perimeter of that unit. In such embodiments, the onboard controller is optionally programmed to react to detection of an object within the predefined distance by stopping the unit, taking evasive action, and/or sending an alert to the control station 55 so that the controller 42 can take corrective action.

In order to control the operation of the fleet of autonomous material handling units, some embodiments of the control station 45 are equipped with network management controls to control the flow and operation of the material handling units within the mine site 46. Such network management controls may be implemented using software executing on a processor to monitor and control the flow of traffic of the material handling units within the mine site 46.

Depending on the implementation, the network management controls are programmed with operating parameters associated with each of the material handling units, including but not limited to maximum speed, braking distance for each speed, maximum payloads, and the like. The network management controls utilise the operating parameters and current positions of the material handling units to determine traffic flows of the material handling units and the effect collision avoidance. For example, network management controls can be utilised to control the speed of two autonomous material handling units that are both approaching the same point on the mine site 46, such that both units pass the point safely while minimising braking and acceleration that increases wear and tear on the vehicles and increases fuel usage.

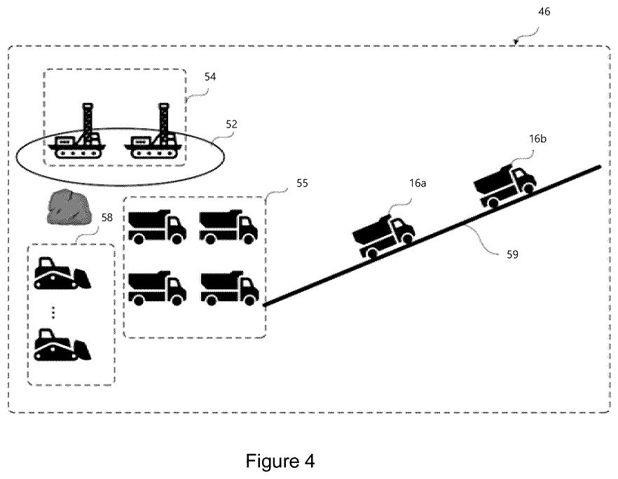

FIG. 4 is a schematic representation of a portion of a mine site 46 having a bench 52 on which a set of drill rigs 54 is operating. The drill rigs 54 drill blast holes, which are subsequently filled with explosives to blast the bench 52 into blast material of a predetermined size. A set of loaders 58 loads the blasted material from the bench 52 into a set of autonomous material handling units in the form of autonomous haul trucks 16a, 16b. Depending on the implementation, the drill rigs 54 and/or the loaders 58 may be human operated or autonomous or a combination thereof. Once the small haulage vehicles have been loaded with blasted material, the haul trucks 16a, 16b travel up a haul road 59 to deliver the blasted material for further processing or to a waste dump.

In the example of FIG. 4, haul trucks 16a and 16b, which may be RSATs, are loaded with blasted material and are travelling on the haul road 59. As the haul trucks 16a, 16b have payload capacities in the range of 1 tonne to 30 tonne as opposed to ultra-class haul trucks with a payload capacity in excess of 200 tonnes, those trucks 16a, 16b are able to negotiate roads with steep gradients in excess of 10% (1 in 10), particularly in the range of 10% (1 in 10) to 16% (1 in 6). Roads with steeper gradients require less excavation and provide shorter travel distances.

As the haul trucks 16a, 16b are significantly smaller than ultra-class haul trucks and inflict significantly less wear on the road surface, it is economical to seal a proportion of roads in the mine site 46 to be used by the fleet of small haulage trucks. Sealing roads allows the small haulage vehicles 16a, 16b to travel at higher speeds, such as 80 km/hr to 100 km/hr or more, reducing the time taken to move blasted material from the bench 52 to subsequent processing or waste sites. In contrast, ultra-class haul trucks have maximum speeds in the order of 60 km/hr, but more typically travel in the range of 40 km/hr. Further small haulage trucks accelerate faster and more efficiently than ultra-class trucks and also brake faster and more efficiently than ultra-class trucks. Accordingly, the mine site 46 is optionally configured with portions of haul roads 59 having gradients in excess of 10% and having portions of haul roads 59 sealed.

In the example of FIG. 4, the loaders 58 optionally load the set of haul trucks 55 based on the type of blasted material that is being moved. Thus, the loaders 58 can sort blasted material into wasted material and ore and then load the fleet of haul trucks 55 with one of the sorted material types.

In some embodiments, a mine site operated with autonomous, haul trucks in conjunction with mobile crushers. The mobile crushers are able to be positioned at a blast site after blasting has occurred to crush the blasted material into a size that is more suitable for haul trucks that are smaller than ultra-class haul trucks.

Crushing the blasted material at the blast site enables the composition of the blast material to be determined at an earlier point of the processing, such that material can be sorted into different trucks or trucks can be sent to different processing sites, based on the composition of the blast material that is being hauled. Further, knowing the composition of the blast material at an earlier time enables subsequent blasting operations to be more efficient. In some circumstances, the blast pattern or explosive is changed based on the most recent blast. In other circumstances, a different area of the mine site is selected for a subsequent blast based on poor composition of a most recent blast.

In a mine site that utilises a fleet of autonomous material handling units, such as autonomous haul trucks, there may be a consequential increased need to manage the flow of traffic around a mine site. Each autonomous vehicle is associated with a Global Positioning System (GPS) device that transmits a present location of the respective vehicle, via satellite, to a central operations centre. Some embodiments utilise control software at the operations centre to control movement of vehicles relative to one another, in accordance with predefined minimum passing distances. Such control software also defines minimum passing distances between a vehicle and other features, such as obstacles, road edges, kerbs, guttering, loaders, markers, and the like.

Using a fleet of smaller, autonomous vehicles will result in an increase in the number of traffic movements relative to a mine site operating traditional, massive equipment. Some embodiments provide a mine site with increased number of slip roads and/or traffic controls in order to manage the movement of vehicles within the site. Such traffic controls may include visual controls, including traffic lights, as well as network controls from a control centre that manage the speeds and directions of autonomous vehicles on the mine site. In some embodiments, vehicle controls, either on the vehicles or effected through controls sent from a control centre, govern the speeds of autonomous vehicles as those vehicles approach intersections, objects, or other vehicles.

Some embodiments utilise a network of wireless transmission towers to communicate with the autonomous vehicles using radiofrequency (RF) transmissions. Wireless transmitters in the autonomous vehicles communicate with a control centre, via the network of transmission towers.

In some embodiments, some or all of the autonomous vehicles are equipped with proximity detectors that detect the presence of objects within a predefined distance of a perimeter of the vehicle. In such vehicles, vehicle control software executing on a processor installed in such vehicles is programmed to activate the brakes of the vehicle or to turn the wheels of the vehicle in order to prevent a collision with a detected object. In some embodiments, the detection of an object within a predefined distance, or range, triggers an alert, such that the vehicle control software transmits a collision alert message to the control centre. On receipt of such a collision alert message, the control centre generates a visual and/or audible alert to attract the attention of an operator in charge of activities in the relevant area of the mine site at which the collision alert message was generated.

According to the present disclosure, a method for moving material in a mine site utilises a plurality of autonomous material handling units.

The material handling units may include one or more loaders, crushers, haulage trucks, trains, and any combination thereof. Each autonomous material handling unit includes a wireless transceiver for communication with a control centre. In some implementations, the autonomous material handling units communicate wirelessly among each other. In some implementations, the control centre sends control signals to the autonomous material handling units to control activities of the autonomous material handling units. Such activities can include, for example, but are not limited, to loading material, moving, stopping, and unloading material.

The mining operation control stations and onboard vehicle controllers of the present disclosure may be practised using one or more computing devices, such as a general-purpose computer, programmable logic controller, embedded computer, or computer server programmed and adapted to function in an improved manner.

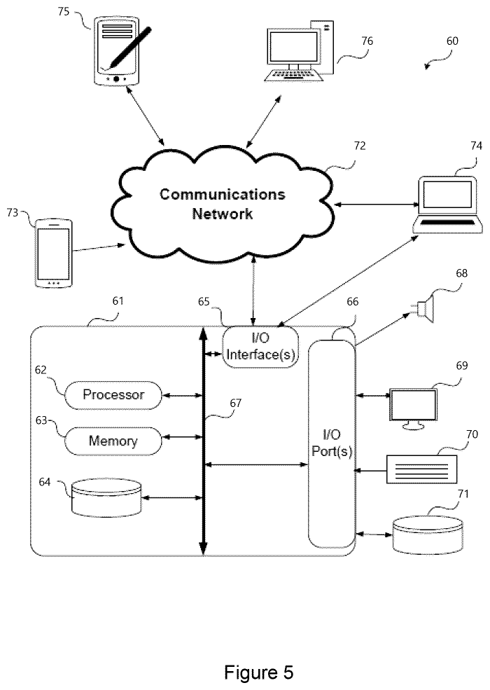

FIG. 5 is a schematic block diagram representation of a system 60 that includes a general-purpose computer 61. The general-purpose computer 61 includes a plurality of components, including: a processor 62, a memory 63, a storage medium 64, input/output (I/O) interfaces 65, and input/output (I/O) ports 66. Components of the general-purpose computer 61 generally communicate with each other using one or more buses 67.

The memory 63 may be implemented using Random Access Memory (RAM), Read Only Memory (ROM), or a combination thereof. The storage medium 64 may be implemented as one or more of a hard disk drive, a solid state “flash” drive, an optical disk drive, or other storage means. The storage medium 64 may be utilised to store one or more computer programs, including an operating system, software applications, and data. In one mode of operation, instructions from one or more computer programs stored in the storage medium 64 are loaded into the memory 63 via the bus 66. Instructions loaded into the memory 63 are then made available via the bus 67 or other means for execution by the processor 62 to implement a mode of operation in accordance with the executed instructions. The computer programs may include network management controls, controls for autonomous vehicles, and onboard vehicle controls.

One or more peripheral devices may be coupled to the general-purpose computer 61 via the I/O ports 66. In the example of FIG. 5, the general-purpose computer 61 is coupled to each of a speaker 68, a display device 69, an input device 70, and an external storage medium 71. The speaker 68 may be implemented using one or more speakers, internal to the computing device 61 or external to the computing device 61, such as in a stereo or surround sound system. In the example in which the general-purpose computer 61 is utilised to implement a control system in accordance with FIG. 3, one or more peripheral devices may relate to the user input devices and alert systems.

The display device 69 may be a computer monitor, such as a cathode ray tube screen, plasma screen, liquid crystal display (LCD) screen, or Light Emitting Diode (LED) display screen. The display 69 may receive information from the computer 61 in a conventional manner, wherein the information is presented on the display device 69 for viewing by a user. The display device 69 may optionally be implemented using a touch screen to enable a user to provide input to the general-purpose computer 61. The touch screen may be, for example, a capacitive touch screen, a resistive touchscreen, a surface acoustic wave touchscreen, or the like. In the example in which the general-purpose computer 61 is utilised to implement the control station 45 of FIG. 3, the display device 69 may display a user interface for receiving inputs from the controller 42 and displaying information relating to the operation and control of the fleet of autonomous material handling units 49 on the mine site 46.

The input device 70 may be a keyboard, a mouse, a stylus, drawing tablet, or any combination thereof, for receiving input from a user.

The external storage medium 71 may include an external hard disk drive (HDD), an optical drive, a flash drive, solid state drive (SSD), or any combination thereof and may be implemented as a single instance or multiple instances of any one or more of those devices. For example, the external storage medium 71 may be implemented as an array of hard disk drives.

The I/O interfaces 65 facilitate the exchange of information between the general-purpose computing device 61 and other computing devices. The I/O interfaces may be implemented using an internal or external modem, an Ethernet connection, or the like, to enable coupling to a transmission medium. In the example of FIG. 5, the I/O interfaces 65 are coupled to a communications network 72 and directly to a computing device 74. The computing device 74 is shown as a personal computer, but may be equally be practised using a smartphone, laptop, or a tablet device. Direct communication between the general-purpose computer 61 and the computing device 74 may be implemented using a wireless or wired transmission link.

The communications network 72 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general-purpose computer 61 is able to communicate via the communications network 72 to other computing devices connected to the communications network 72, such as the mobile telephone handset 73, the touchscreen smartphone 75, the personal computer 76, and the computing device 74.

One or more instances of the general-purpose computer 61 may be utilised to implement a control station or onboard controller in accordance with the present disclosure. In such an embodiment, the memory 63 and storage 64 are utilised to store data relating to the configuration and operating parameters of a fleet of autonomous material handling units 49 at one or more mine sites 46. Software for implementing the control system is stored in one or both of the memory 63 and storage 64 for execution on the processor 62.

### Chapter IV—Coordinating Loading of Haul Trucks

This chapter outlines an embodiment in which autonomous material handling units in the form of autonomous loading vehicles can be coordinated to minimize risk of collisions when loading autonomous haul trucks.

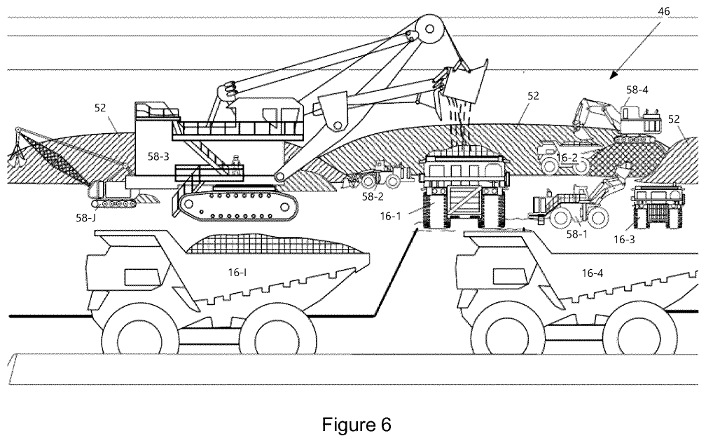

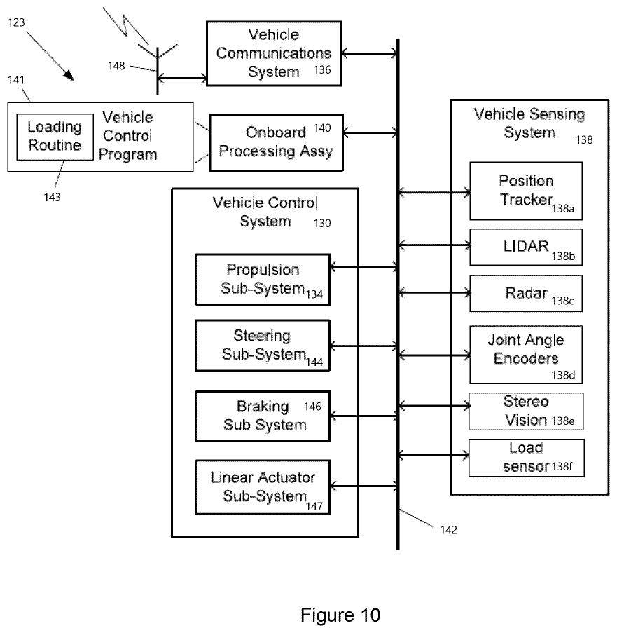

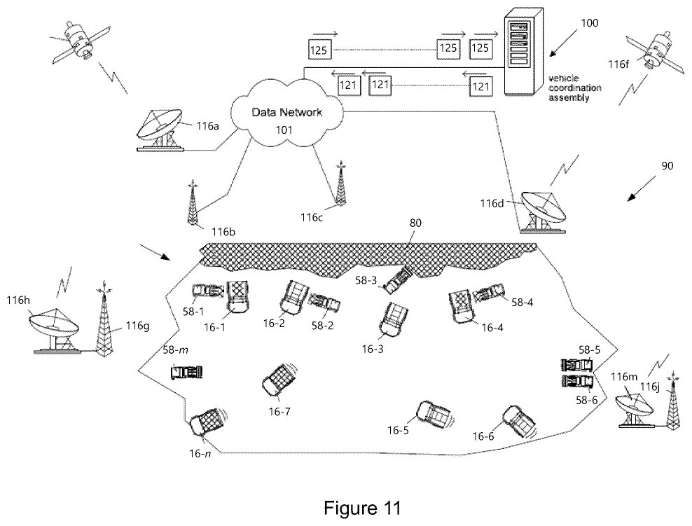

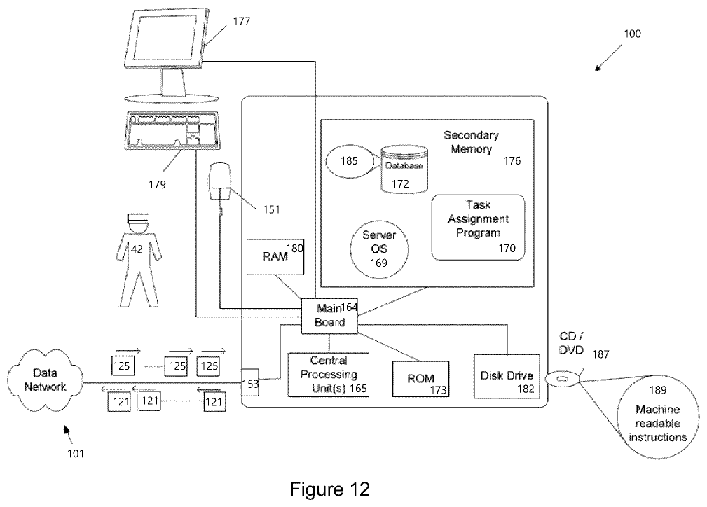

In order to provide an overview, the present disclosure relates to a method to load a number of haul trucks such as haul trucks 16-1, . . . , 16-5 as shown in FIG. 6, with material, for example material 80, in an operational area such as a blasted bench 52 of an open cut mine 46. In an embodiment the method involves using a plurality of loading vehicles, such as front-end loaders 58-1, . . . , 58-5, and other types of loading vehicles as well. Examples of loading vehicle in the form of a front-end loader appear in FIGS. 6 to 9, 11 and 13 to 15. During performance of the method a vehicle coordination assembly, such as vehicle coordination assembly 100 (FIGS. 11 and 12), is operated to establish data communications with vehicle sensing systems, illustrated as item 108 of FIG. 10, of the haul trucks and of the loading vehicles via a data network 101, which is shown in FIGS. 11 and 12.

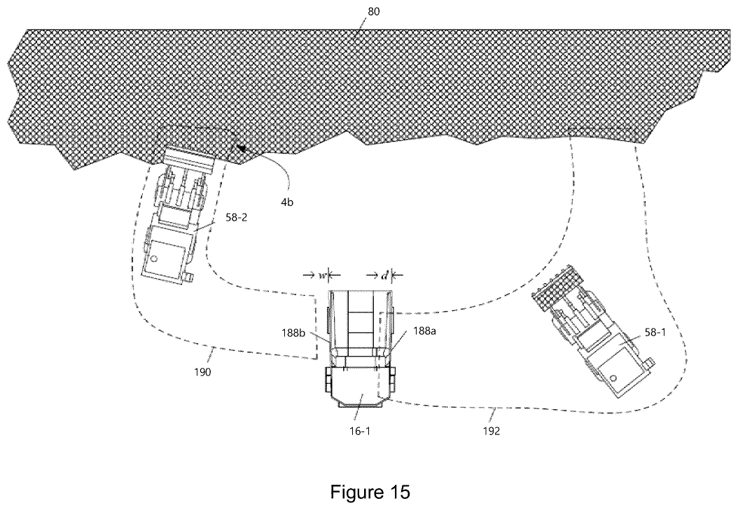

The method involves operating the vehicle coordination assembly 100 to determine load-ready haul trucks. For example, FIG. 15 shows an empty and stationary haul truck 16-1 that is adjacent blasted bench material 80 and thus is ready for loading and so may be referred to as a “load-ready haul truck”. Typically, the vehicle coordination assembly 100 determines that a haul truck is load-ready simply by receiving a message to that effect from the haul truck via the data network 101. The pose of the haul truck 16-1, i.e., its position, orientation, and state of readiness to be loaded, i.e. a load-ready haul truck, as shown in FIG. 15 is ascertained by haul truck 16-1's vehicle sensing system 138 (FIG. 10) and sent to the vehicle coordination assembly 100 using haul truck 16-1's vehicle communications system 136. The pose information is sent via data network 101 and comprises pose data messages 125 (FIGS. 11 and 12), which emanates from the vehicle sensing system 138. Consequently, the vehicle coordination assembly 100 is able to track the pose of each of the haul trucks and of each of the loading vehicles and indeed of all other similarly equipped material handling units in the operational area.

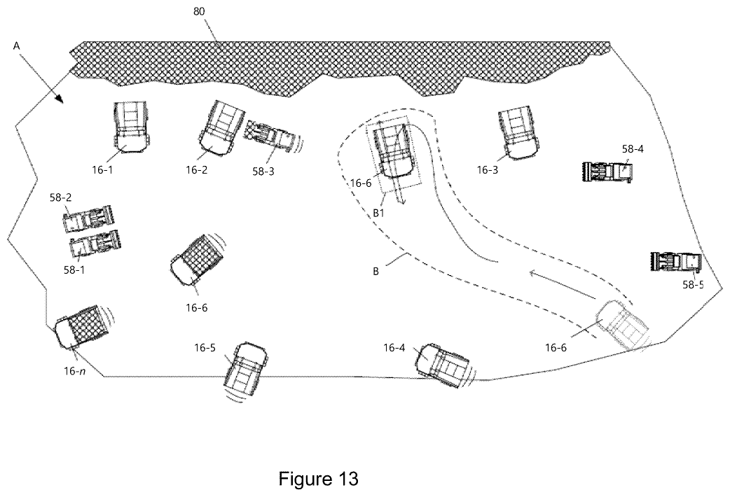

The vehicle coordination assembly 100, configured by task assignment program 170 (FIG. 13) selects at least two loading vehicles, for example front-end loaders 58-1, 58-2 to load the load-ready haul trucks (e.g. truck 16-1 of FIG. 13). The selection vehicle coordination assembly 100 then assigns a loading task to two or more of the loading vehicles to load the load-ready haul truck.

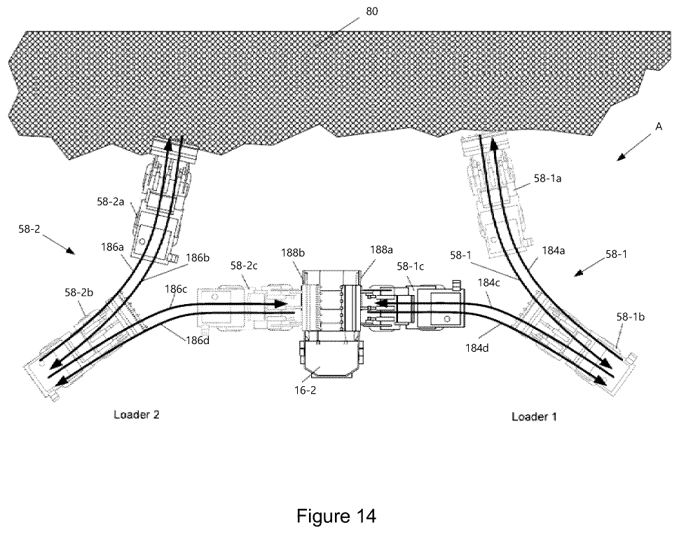

Each task specifies a respective safe operating space for the loader to which the task has been assigned. The safe operating space is a space in which a loading vehicle is restricted to operating. For example, safe operating spaces 190 and 192 for loading vehicles 16-2 and 16-1 respectively are illustrated in FIG. 15. Vehicle coordination assembly 102 allocates the safe operating spaces the loading vehicles for them to operate therein without risk of collision with other loaders. FIG. 14 illustrates possible paths that the loading vehicles may follow when implementing their assigned loading tasks with initial safe operating spaces 190 and 192 as shown in FIG. 15.

Vehicle coordination assembly 100 sets the safe operating space in respect of one of the assigned loading vehicles to extend from a region of the material in the operational area over a side of the haul truck, whilst setting each safe operating space in respect of other of the assigned loading vehicles to fall short of a side of the haul truck. For example, referring again to FIG. 15, it can be seen that the safe operating space 192 allocated to loading vehicle 58-1 extends a distance d over a side 188a of haul truck 16-1 whereas the operating space 190 allocated to loading vehicle 58-2 falls short of the opposite side 188b by a distance w. Consequently, only the assigned loading vehicle 58-1 with the safe operating space 192 extending over the side 188a of the haul truck 16-1 is able to perform a dumping operation to the haul truck 16-1 at the time illustrated in FIG. 15. Loading vehicle 58-2 is able to fill its bucket at a region 4b of material 80, which is located within its present safe operating space 190 but cannot proceed to dump the material over side 188b into haul truck 16-1 while its safe operating space falls short of side 188b of haul truck 16-1.

Upon determining completion of the dumping operation by loading vehicle 4-1, the vehicle coordination assembly 100, revises the safe operating spaces 190 and 192 to allow a next loading vehicle, e.g. vehicle 58-2 to perform a dumping operation to the haul truck 16-1 whilst preventing other loading vehicles, for example loading vehicle 58-1 from performing a further dumping operation over side 188a and in to the haul truck 16-1.

The vehicle coordination assembly 100 transmits the respective loading tasks that have been assigned to the loading vehicles via data network 101 in a task assignment message 121 (FIGS. 11 and 12).

Upon receiving the task assignment message 121 each loading vehicle implements the loading task with their onboard processing assembly 140 (FIG. 10) configured by vehicle control program 141. Processing assembly 140 applies the task assignment parameters to a material loading routine 143 stored in its onboard vehicle control program 141. The material loading routine 143 as executed by onboard processing assembly 140 commands the vehicle control system 130 to navigate to the mined material to be picked-up, within the safe operating space, picking-up the mined material in the loading vehicle's bucket and if allowed by the current setting of its safe operating space, dump the material from the bucket into a tray of a haul truck 16.

Now that an overview has been provided, further details of a method, and system according to one or more preferred embodiments will be discussed.

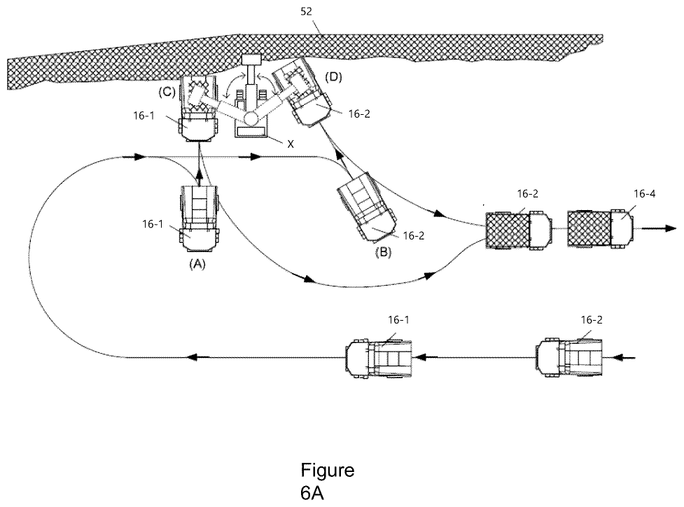

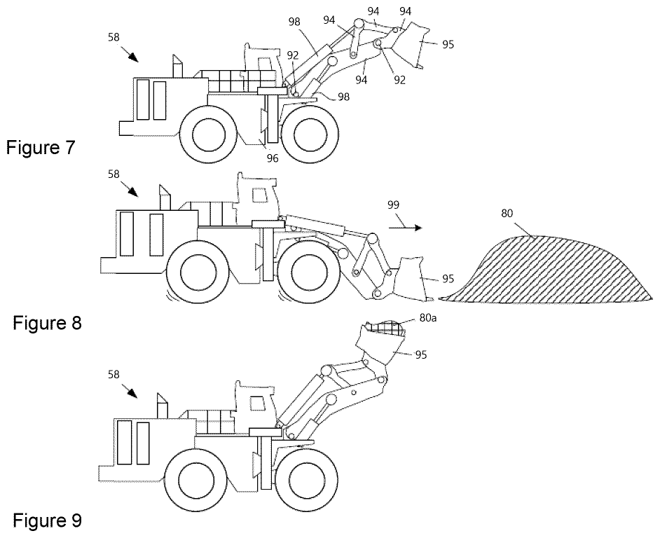

With reference to FIGS. 7 to 9, a loading vehicle such as front-end loader 58 is fitted with a bucket 95 which is supported by a linkage of rigid members 94 interconnected by joints 92 to a chassis 96 of the front-end loader 58. By operating hydraulic actuators 98, angles of the members 94 at joints 92 are manipulated to raise and lower the bucket 95 and consequently by driving the front-end loader 58 forward, as indicated by arrow 99 into material 80 the bucket 95 can be raised with loaded with material 80a as shown in FIG. 9 and then driven to a haul truck where the load 80a is deposited.

FIG. 10 is a block diagram of a vehicle control and sensing system 123 of the haul trucks and loading vehicles in an exemplary embodiment. The vehicle control and sensing system 123 includes a data bus 142 which facilitates electronic data communication between onboard processing assembly 140 which executes instructions comprising a vehicle control program 141 and thus is configured to coordinate interactions between:

Vehicle control system 130 sub-systems, namely:
Propulsion Sub-System 134,
Steering Sub-System 144,
Braking Sub-System 146 and
Linear Actuator Sub-System 147; and

Vehicle sensing system 138 assemblies, namely:
Position Tracker Assembly 138a,
LIDAR Assembly 138b,
Radar Assembly 138c,
Joint Angle Encoders Assembly 138d,
Stereo Vision Assembly 138c, and
Load Sensor 138f.

Vehicle control system 130 includes sub-systems 134, 144, 146, 147 which, under control of the onboard processing assembly 140 enable a vehicle, such as a front-end loader to operate autonomously. In particular, the vehicle control program includes instructions for the onboard processing assembly 140 to implement a task assigned to it. Where the vehicle comprises a haul truck the task may be to move to a destination and operate its tray to unload.

Where the vehicle comprises a loading vehicle the onboard processing assembly can implement a task for the vehicle to navigate to blasted material and to navigate to the haul truck for dumping, by taking into account data from the vehicle sensing system 138 and processing that data to generate commands for the various sub-systems of the vehicle control system 130.

As illustrated in FIG. 10, vehicle control and sensing system 123 includes a vehicle sensing system 138 which in turn includes a number of assemblies 138a-138f for determining the vehicle's pose, which will typically comprise data such as the vehicles position, speed, direction, proximity to other vehicles, orientation and joint angles.

Position tracker 138a may comprise a Global Positioning System (GPS) receiver which is configured to generate information about at least the position of the vehicle at each of a series of times, for example five second intervals. The position tracker may also be configured to triangulate a position estimate from terrestrial transmitters such as wireless transceivers 116a, 116b shown in FIG. 11, which are part of data network 131. The position tracker 132 may also include gyroscopes, accelerometers and/or other apparatus that can also be used to generate position signals indicating the location of the vehicle to which it is fitted within the mine environment. The position tracker 138a is able to ascertain at least the vehicle's position at progressive times as it travels through the area. Depending on the resolution of the data that the tracker provides to the vehicle communications system 136, it is possible to determine speed direction and orientation data that is transmitted via vehicle communications system 136 for logging and processing by another processing assembly such as vehicle coordination assembly 100, shown in FIG. 11. In the presently described exemplary embodiment, the vehicle tracking system 138 includes load sensors for gauging the weight of the load being hauled so that it is possible to determine if a haul truck tray or bucket of a loading vehicle is laden or empty. Vehicle tracking system 138 also includes LIDAR sensor 138b, radar sensor 138c and stereo vision sensors 138e for estimating proximity to obstacles and for assisting in collision avoidance and loading and unloading of material. Joint angle encoders 138d are also provided in the vehicle tracking system to generate signals indicating the angle of various joints including steering angle, bucket angle, and loader arm angles.

Vehicle communications system 136 which is coupled to an antenna 148 for transmitting radio frequency data communications to the data network 101, of which terrestrial receivers 116a, 116b (FIG. 11) are part. The vehicle communication system 136 receives messages and commands via the data network 101 from vehicle coordination assembly 100. For example, where the vehicle control and tracking system 123 is incorporated into a loading vehicle, such as a front-end loader, the vehicle communication system 136 will receive task assignment messages 121 for implementing loading of haul trucks. The data network 101 includes a collection of wireless data transceivers 116a, . . . , 116m including satellite and terrestrial transceivers suitable for implementing wireless communication protocols such as WiFi, WiMax, GPRS, EDGE or equivalent terrestrial and satellite wireless data communications. It will be appreciated that these network architectures are provided as examples only and thus are not limiting.

Referring now to FIG. 12, a vehicle coordination assembly 100 is depicted according to the presently described exemplary embodiment of the invention.

Vehicle coordination assembly 100 acquires pose data for each of the material handling unit in the operational area, including the haul trucks and the loading vehicles, via a stream of pose data messages 125 from the vehicles 16-1, . . . , 16-I via the data network 101 which provide location estimates for the vehicles within a defined coordinate frame. The pose data messages contain information such as a position coordinate, time at which the position current orientation, current posture of components such as trays, arms and buckets, and information about when the message was generated from which material handling units.

The pose data messages may comprise, or be based, on data from any/all of positioning systems such as US GPS, Russian GLONASS, EU's Galileo positioning system, China's Beidou positioning system or local positioning systems such as India's NavIC and Japan's QZSS.

It will be realized that Global Navigation Satellite Systems (GNSS) such as the US owned Global Positioning System (GPS) is one method of obtaining localization data, other methods such as cell-tower-triangulation based localization might also be used as an alternative or in addition to GNSS.

As will be explained, the vehicle coordination assembly 100 is configured to process the pose data messages 125 and determine task assignments 121, which are transmitted across the data network 100, to the loading vehicles 16 to effect transfer of material 80 to the haul trucks 16.

The vehicle coordination assembly 100 is provided in the form of a specially configured processing assembly that is in data communication with vehicle tracking and control systems 123 of the haul trucks and the loading vehicles via data network 101.

The embodiment of the vehicle coordination assembly 100 that will be described is a preferred implementation but not the only possible implementation. In other embodiments the vehicle coordination assembly 100 may be implemented as a distributed or decentralized assembly. For example, in other embodiments the vehicle coordination assembly 100 may be implemented as a number of servers that each cooperate with each other to undertake different steps of the method that will be described.

Vehicle coordination assembly 100 includes a main board 164 which includes circuitry for powering and interfacing to a processing assembly comprising one or more onboard microprocessors or “CPUs” 615.

The main board 164 acts as an interface between CPUs 165 and an electronic memory assembly in the form of a secondary memory 176. The secondary memory 176 typically comprises one or more magnetic or solid-state drives. The secondary memory 176 stores instructions for an operating system 169. The main board 164 also communicates with random access memory (RAM) 180 and read only memory (ROM) 173. The ROM 173 typically stores instructions for a startup routine, such as a Basic Input Output System (BIOS) or Unified Extensible Firmware Interface (UEFI) which CPUs 165 access upon start up and which preps the CPUs 165 for loading of the operating system 169.

The main board 164 also includes an integrated graphics adapter for driving display 177. The main board 164 accesses a data communications assembly in the form of adaptor 153, for example a LAN adaptor or a modem, that places the vehicle coordination assembly 100 in data communication with data network 101.

An operator 42 of vehicle coordination assembly 100 may interfaces with it by means of a human-machine-interface in the form of keyboard 179, mouse 151 and display 177 but more usually the vehicle coordination assembly will not have a hardware human-machine-interface but rather administrator 167 will log in remotely. For example, by means of a remote terminal application that is part of Server OS 169.

Subsequent to the BIOS or UEFI booting up the server the operator 167 may operate the operating system 169 to load the Task assignment program 170. The Task assignment program 170 may be provided as tangible, non-transitory, machine-readable instructions 189 borne upon a computer readable media such as optical disk 187 for reading by disk drive 182. Alternatively, Task assignment program 170 may also be downloaded via port 153.

As mentioned, the secondary memory 177, is typically implemented by a magnetic or solid-state data drive and stores the operating system 169, for example Microsoft Windows Server, and Linux Ubuntu Server are two examples of such an operating system.

The secondary memory 176 also includes the Task assignment program 170, which configures the vehicle coordination assembly 100 to assign tasks for the loading vehicles to effect loading of material into the haul trucks with collision avoidance. The Task assignment program includes instructions for the vehicle coordination assembly 100 to revise the safe operating spaces for the loading vehicles, which has been previously mentioned, prevents or allows particular loading vehicles to dump material into a load-ready haul truck whilst preventing simultaneous dumping of loading vehicle buckets into the haul truck and thus a potential collision.

During operation of the vehicle coordination assembly 100 the one or more CPUs 165 load the operating system 169 and then load the Task assignment program 170.

It will be realized that the illustrated arrangement of the vehicle coordination assembly 100 is simply one example of its arrangement. Other suitable arrangements are also possible, for example the program 170 could be executed by the vehicle coordination assembly 100 in the form of a virtual machine in a cloud computing environment to thereby implement a specially configured vehicle coordination assembly.

Methods that are implemented by the vehicle coordination assembly 100 under control of the Task assignment program 170 in order to process the vehicle pose data messages 125 to generate the assignment messages 121 will be described. These methods are coded as machine readable instructions, which comprise the Task assignment program 170, for execution by CPUs 165.

To recap, material handling units in an open cut mining bench area include haul trucks, which need to be loaded and loading vehicles for loading the haul trucks. The material handling units are autonomous, and they are equipped with control systems and sensing systems. The sensing systems create a sequence of pose data messages 125. The pose data messages specify the pose of the material handling units, e.g. haul trucks 16 and loading vehicles 58 and include information such as the orientation, position of the vehicle and also information such as the extension, height and angle of booms, arms and buckets of the material handling units.

A vehicle coordination assembly 100 is provided which facilitates coordination of the loading vehicles 58 for loading the haul trucks 16 via a data network 101.

The central vehicle coordination assembly 100 receives the pose data messages 125 from each of the material handling units.

Upon a haul truck, for example truck 16-6, initially shown in dotted line in FIG. 13, entering the operational area A, the vehicle coordination assembly 100 searches for an available loading bay, which may be a pre-designated parking bay or may simply be an area that is free and in proximity to material (such as a pile of blasted bench material) in the operational area to be loaded into the haul truck. The operational area is typically an area on a bench of an open cut mine, adjacent a pile of blasted material. For example, in FIG. 13 haul truck 16-6, upon entering area A is allocated a corridor B which is a safe operating space that is sufficiently large for haul truck 16-6 to turn around in and assume a load ready pose in loading bay B1.

The vehicle coordination assembly 100 allocates a corridor to a haul truck for it to travel from its current position to the available loading bay taking into account the pose and trajectories of other material handling units in the operational area in order to avoid collisions as the haul truck moves along the corridor. It should be realised that in the context of a bench of an open cut mine, “corridors” are generally not roads. Corridors are transitionary and only exist while a vehicle is transiting the corridor. As a vehicle transits along a corridor, the already transited portion of the corridor “disappears” behind it. A corridor is not a semi-permanent construct, for example one that exists even when the vehicle is not transiting along it.

As the haul truck moves to the available loading bay other vehicles moving along intersecting corridors may assume higher priority so that the Vehicle coordination assembly 33 may send a pause, slow-down, or speed-up command to the haul truck or may update the path taken by the provisional corridor for collision avoidance.

The haul truck 16-6 parks at the loading bay B1 with a load-ready pose, i.e., a position and orientation for loading and a configuration for loading, such as having its tray down and ready to accept material. For example, typically the haul truck will assume a pose that places a rear of the truck toward the pile of material 80. The vehicle coordination assembly 100 determines that the haul truck, once at the loading bay, is available for loading. That may be inferred from the pose data messages or, more preferably it is done by the haul truck sending a “load-ready” message in its pose data messages 125 to the vehicle coordination assembly 100.

Referring now to FIG. 14, in one example, with respect to load-ready haul truck 16-1 the vehicle coordination assembly 100 selects two or more loading vehicles, being loading vehicles 58-2 and 58-1 that it assigns to load each load-ready haul truck, such as haul truck 58-6, in the operational area A. In FIG. 14, loading vehicle 58-2 is shown at its current position 58-2a in solid line and at other positions 58-2b and 58-2c, during performance of its loading task, in dotted line. Similarly, loading vehicle 58-1 is shown at its current position 58-1c in sold line and at other positions 58-1b, 58-1a, during performance of its loading task, in dotted line.

Task assignment program 170 (FIG. 12) may include instructions configuring the vehicle coordination assembly 100 to select the two or more loading vehicles, (58-1, 58-2) to load each of the load-ready haul trucks, simply on the basis of distance of the loading vehicles to the haul trucks but more preferably, taking into account a range of factors such as proximity, overall material flow (where to dig from and how to advance the dig face), material blending (e.g. some trucks may have waste other may have ore), etc. Overall optimisations take all into account to produce best dig sequence. Furthermore, other considerations include what types of loading vehicles are available/free and what combination of loading vehicles can be simultaneously assigned to the loading of a truck. For example, if two excavators and two shovels are free, one excavator and one shovel may be assigned to a truck rather than two excavators, regardless of which vehicle is closest.

Once the vehicle coordination assembly 100 has selected the two or more loading vehicles it transmits respective bucket dumping task assignments to them.

The task assignments for each assigned loading vehicle will typically include:
1. The position and loading side of the haul truck.
2. A safe operating area in the form of a corridor in which the loading vehicle can operate the corridor allows the loading vehicle to move from a region of the pile to the loading side of the haul truck.
3. An operational time window, being an expected time frame for the loading vehicle bucket dumping operation to occur.

The vehicle coordination assembly 100 continues to monitor the pose of each of the loading vehicles (and all other material handling units in the operational area) for collision avoidance.

The task assignments are on a loading vehicle bucket load-by-load basis. By “load-by-load basis” it is meant that the vehicle coordination assembly 100 issues a task to a loading vehicle each time it receives a message from the loading vehicle confirming that the loading vehicle has completed a task, which is a task of dumping a bucket load of material into its assigned haul truck. Accordingly, the loading vehicles may initially start to load a first haul truck and some of them may continue to load that haul truck until it is fully loaded whilst others may be assigned to other haul trucks prior to complete loading of the initially assigned haul truck occurring.

Therefore, it will be realised that the vehicle coordination assembly 100 does not necessarily assign task assignments to all the assigned loading vehicles at approximately the same time. If there happens to be two loading vehicles that need loading assignments at the same time, then they may both receive their task assignments at approximately the same time. However, most of the time, task assignments will be assigned to loading vehicles at different times, specifically when a loading vehicle needs one.

The vehicle coordination assembly 100 may also issue task assignments to a loading vehicle midway through a task. For example, a loading vehicle that was originally tasked with dumping its current load into truck A may be dynamically assigned to dump its load into truck B even though its already on its way to truck A.

An example will now be described. In the following T1, T2, etc correspond to task assignments 125 generated by the vehicle coordination assembly 100:

### EXAMPLE

Vehicle coordination assembly 100 sends task T1 to Loader 1 and task T2 to Loader 2

T1: Loader 1, Load haul truck HT1 from side S1. Your corridor extends from the area of the pile (e.g. area P_x1y1), from which you are to load your bucket and comprises corridor C1. When corridor C1 extends over the side S1 of HT1 then dump your bucket into HT1.

T2: Loader 2, your task is to load haul truck HT1 from side S2. Your corridor extends from the area of the pile (e.g. area P_x2y2), from which you are to load your bucket, and comprises corridor C2. When corridor C2 extends over the side S2 of HT1 then dump your bucket into HT1.

Initially vehicle coordination assembly 100 sets corridor C1 so that it extends over the side of S1 and sets corridor C2 so that it does not extend over the side S2. Consequently, both Loader 1 and Loader 2 proceed to load their buckets from the areas of the pile, P_xlyl and P_x2y2 that their corridor extends to, but, initially only Loader 1 can dump into haul truck HT1 because its corridor C1 extends over the side of S1 of the haul truck HT1 whereas C2 does not extend over side S2 so that Loader 2 recognises that it cannot reach HT1 for its bucket dumping operation.

Loader 1 dumps into haul truck HT1 and sends a message confirming that it has done so and as part of its onboard dumping automation procedure it also reverses from the side S1 of HT1.

In response to receiving the message from Loader 1 the vehicle coordination assembly 100 retracts corridor C1, or makes it cease to exist, so that it no longer extends over the side S1 of HT1. At about the same time the vehicle coordination assembly 100 extends corridor C2 over the side S2 of HT1. In response to the extension of corridor C2, Loader 2 dumps its bucket load over side S2 and into HT1, reverses from HT1 and sends a message confirming that it has dumped its bucket load into HT1 back to the vehicle coordination assembly 100.

The vehicle coordination assembly 100 now retracts corridor 2 from HT1, or makes it cease to exist, so that Loader 2 cannot reach HT1 and extends corridor C1 or creates a new corridor extending over side S1 of HT1. Alternatively, since Loader 1 has previously already completed its dump it is more than likely that Loader 1 is on its way to pick up another load when Loader 2 has just completed its dump. Accordingly, the vehicle coordination assembly 100 will find it more efficient to assign to Loader 1 a corridor to get it to its new load to pick up, i.e. is to fill its bucket with material rather than extend Loader 1's old corridor to again extend over the side S1 of HT1.

The vehicle coordination assembly 100 now sends further tasks, for example it may send further tasks that simply repeat T1 and T2 until it receives a “loading completed” message from the haul truck HT1 stating that HT1 has a full payload. When the vehicle coordination assembly 100 receives a loading completed message it updates its database to indicate that Loader 1 and Loader 2 are free for new assignments. Depending on the pose messages that HT1 sends to vehicle coordination assembly 100, vehicle coordination assembly 100 may be able to determine that there is only one more bucket load to be dumped into HT1 before it will reach loading completed status. In that case it may assign a new assignment to Loader 1 before Loader 2 has completed its final bucket dump into HT1.

The tasks will typically also include a timeframe for completion. If a task is not completed within the allocated timeframe then the vehicle coordination assembly 100 may extend the timeframe, and potentially also the timeframe of other loading vehicles that are assigned to load the same haul truck. The vehicle coordination assembly 100 may request diagnostic information from the loading vehicle and, if it appears that there is a functional impairment of the loading vehicle, end its task assignment and possibly flag the loading vehicle for maintenance.

Alternatively, vehicle coordination assembly 100 may determine for operational reasons that the assignment of loaders should change for one or both of Loader 1 and Loader 2 after they have completed their first bucket dump into HT1. For example, the vehicle coordination assembly 100 may determine that another haul truck, HT2, needs to receive a bucket dump of material from location P_x3y3 of the pile dumped into it. That may occur to bring the final load in HT2 to a desired blend for example. In that event vehicle coordination assembly 100 may assign Loader 1 to HT2 and assign another loading vehicle, Loader 3 to HT1. The tasks in that case may then be as follows:

T3: Loader 1, Load haul truck HT2 from side S2. Your corridor extends from the area of the pile P_x3y3 from which you are to load your bucket and comprises corridor C3. When corridor C3 extends over the side S2 of HT2, dump your bucket into HT1.

T4: Loader 2, load haul truck HT1 from side S2. Your corridor extends from the area of the pile (e.g. area P_x2y2) from which you are to load your bucket and comprises corridor C2. When corridor C2 extends over the side S2 of HT1, dump your bucket into HT1.

As before, the vehicle coordination assembly 100 retracts and extends the corridors or cancels and creates corridors so that corridors to each side of a haul truck to be loaded do not extend over the opposed sides of the haul truck at the same time so that there is no risk of the buckets of the respective loading vehicles colliding.

It should be recalled that corridors are preferably transitory so that new corridors are constantly generated every time any vehicle has to move somewhere new, even if that ‘new’ destination is back where it just came from. Consequently, while dozer 58-1 of FIG. 15 is picking up more material from the pile 80, it is possible that another dozer “58-x” (not shown) could dump its load into truck 16-1 from the right-hand side depending on the task allocations.

For example, with reference to FIG. 15:
1. Dozer 58-1 has picked up a load from the pile 80.
2. Dozer 58-1 is allocated a corridor allowing it to travel safely from its current position to side S1 188a of truck 16-1.
3. As dozer 58-1 transits along the corridor, the already transited portions of the corridor behind dozer 58-1 ‘disappear’.
4. As dozer 58-1 nears side S1 188a a check is done to see if any other loading vehicle is currently dumping a load into truck 16-1. That is, a check is done to see if there exist any corridors that overlap any one of the sides S1 188a, S2 188b of the truck 16-1.
5. If there are no corridors overlapping any of sides S1 188a and S2 188b, then dozer 58-1's corridor is extended to overlap side S1 188a.
6. Dozer 58-1 dumps its load over side S1 188a.
7. Dozer 58-1 has thus completed 1 cycle/route and asks for (or perhaps is already provided with) its next task instruction.
8. A new corridor is generated for dozer 58-1 to allow it to fulfil its next task instruction; which may be to simply go back to the pile 80 along the route it just took.

An advantage of the loading system that has been described is that while it allows two, or more, loading vehicles to be assigned to load a common haul truck at the same time so that they can simultaneously proceed with digging the pile to fill their buckets and travelling to the pile and from the pile towards the haul truck, it avoids simultaneous dumping into the haul truck at the same time to avoid collision, such as a clash of the loading vehicles' buckets.

The system coordinates loading tasks of two or more loading vehicles with a view to optimizing maximum loading throughput to one or more haul trucks. Without a coordination assembly, such as the vehicle coordination assembly 100 this assigning of two loaders to one truck would not be possible without a high risk of collision because a loading vehicle's sensing system cannot readily see the other loader nor coordinate with it effectively when they are loading on opposite sides of the same vehicle. The vehicle coordination assembly 100 provides for synchronising the loading of two or more loading units, by coordinating extension and retraction of the respective safe operational corridors for each loading vehicle on opposite sides of the haul truck, to significantly increase overall dig rate.

During the transfer and loading operations, the vehicle coordination assembly 100 may effect collision avoidance whilst determining the task assignments to prevent interference of the each of the first and second loading vehicles with each other. Alternatively, or additionally each of the material handling units in the region of the blasted bench, including the loading vehicles 58-1, 58-2 and haul truck 16-1 will also preferably implement obstacle and collision avoidance using their onboard processors 140 configured by instructions comprising the vehicle control program 41 and taking into account sensing data received from the various assemblies of the vehicle tracking system, such as one or more of the LIDAR, RADAR and Stereo Vision assemblies. As previously discussed, collision avoidance is also affected by way of the pose data messages, and the processing thereof by the vehicle coordination assembly 100 to specify loading windows, loading bubbles, limits on pose, etc.

The method may include operating the vehicle coordination assembly 100 to track all material handling units in the area of interest, e.g. the region of the blasted bench material 80 illustrated in FIG. 6. In an exemplary embodiment the vehicle coordination system 100 effects collision avoidance whilst determining loading task assignments taking into account positions of all of the material handling units in the area of interest.

For example, with reference to FIG. 15 the vehicle coordination assembly 100 may be configured by the task assignment program 170 to effect collision avoidance between the material handling units by allocating safe operation bounding boxes 191, 192 to the first and second loading vehicles. Consequently, the onboard vehicle control and tracking system 123 of the loading vehicles 58-1, 58-2, and similarly of other material handling units in the region, are made aware that they can proceed with minimal onboard collision detection so long as they operate within their allocated bounding box. As a result, they may be able to move more quickly within the bounding boxes 190, 192 as collision avoidance processing can be minimised.

In the presently described exemplary embodiment the first and second sequences of tasks are determined by the vehicle coordination assembly 100 to prevent overlap of the safe operation bounding boxes at any given time to facilitate collision avoidance.

After a haul truck, e.g. truck 16-1 in FIG. 15, has been filled, the vehicle coordination assembly 100 can check that it is indeed loaded with material by monitoring load weight data in the information that is received from the vehicle control and tracking assembly 123 of the haul truck 16-1. Alternatively, the haul truck may simply transmit a “loading completed” message in its pose data messages 125. The vehicle coordination assembly 100 sends a “move” command to the haul vehicle via the data network 131, which the haul truck responds to by moving away from the loading bay so that an empty truck can then take its place for further loading.

As previously mentioned, the vehicle coordination assembly 100 may store dimensions of the loading truck and of the first loading vehicle and the second loading vehicle in a data storage assembly. For example, the vehicle coordination assembly 100 may store those dimensions, and also the dimensions of other material handling units, such as those discussed with reference to FIG. 6 in a table 185 of a database 172, as shown in FIG. 12.

It will be realized that other embodiments are encompassed, for example, in one scenario a multiple (, i.e., “N”) number of haul trucks are made available in a loading area. At least N+1 loading vehicles are provided. The vehicle coordination assembly 100 is configured to implement the dumping of material from the loading vehicles into one or more haul trucks. In a variant of the above example, each of the N+1 loading vehicles carry a known material type such as grade, and the vehicle coordination assembly 100 is configured to implement the dumping of material into one or more haul trucks associated with that grade.

One or more embodiment discussed herein are of economic value because they provide one or more of the following advantages:
1. Allows simultaneous loading assignments to be assigned to loading vehicles for loading haul trucks, such as a smaller truck that can travel on a public road, from both sides of the truck.
2. Allows multiple loading vehicles, and other material handling units, to operate in close proximity to each other with minimal risk of accidents.
3. Allows a consistent flow of incoming and departing trucks.
4. Allows for use of smaller, more efficient excavators, for example front-end loaders, compared to existing larger mining excavators.
5. Increases attractiveness of frontend loaders as primary loading mechanism, which are more efficient than excavators.
6. Allows smaller haul trucks to operate on 3 to 10 metre (in height) benches, in particular around 5 metre (in height) benches, rather than 10+ metre (in height) benches when using existing mining trucks because the front-end loaders can operate on smaller benches and the risk of collision is reduced. The bench dimension that have been mentioned are for bench height and block size (where a bench can be subdivided into blocks). The overall width of a bench can also be decreased. Ordinarily to comfortably accommodate for Ultra-class haul trucks bench widths are around 70 m+, but that can be reduced to around 50 m, for example.
7. Allows for Improved resolution of stockpiles.

### Chapter V—In-Pit Material Categorisation

This chapter describes an embodiment in which mined material at a mine site, for example in a pit 12, can be categorized, i.e. graded, prior to being loaded into haul trucks 16 or other material handling units.

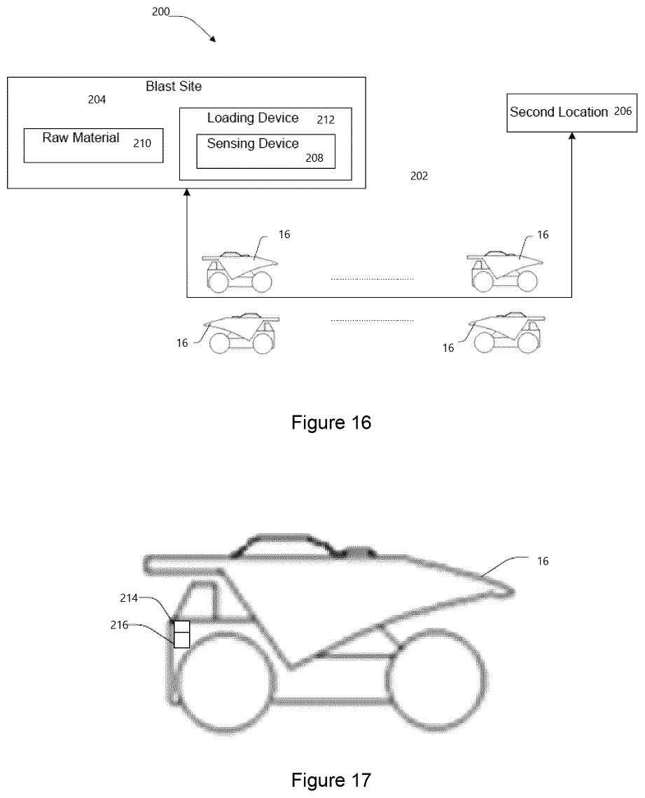

Referring initially to FIGS. 16, there is illustrated a material categorisation and transportation system 200 including a plurality of haul trucks 16 for transporting material within a mine site 202 from a first location in the form of a blast site 204 to a second location 206. System 200 includes a sensing device 208 for actively sensing chemical property characteristics of raw blasted mined material 210 such that raw material 210 can be categorised into a plurality of material categories based on the sensed characteristics. System 200 further includes a loading device 212 located at blast site 204 for loading raw material 210 into a predefined one of haul trucks 16 based on material category for transportation to second location 206. The system is such that each of haul trucks 16 only carries raw material 210 of a predetermined one of the material categories.

Autonomous material handling units in the form of autonomous haul trucks are generally able to function without a dedicated driver or control person as they include a controller (in this case, each of haul trucks 16 includes a respective controller 214) that is programmed to drive the truck in the preconfigured fashion. The controller 214 may comprise the onboard processing assembly 140 and vehicle control system 130 as described in Chapter IV. The controller 214 will often include or be coupled to a communications unit (in this case, each of haul trucks 16 includes a respective vehicle communications unit 216) that will be in wireless communication with a manned central controller of mine site 202, where that central controller (itself clearly including wireless communications functionality) monitors one or more autonomous trucks and where the autonomous travel and movement of the trucks can be altered as required by way of the central controller. The communications unit 216 may comprise the vehicle communications system 136 as described in Chapter IV. It will be appreciated that, in other embodiments, the autonomous functionality of autonomous trucks includes movement that is not limited to predefined route. For example, an autonomous haul truck could be preconfigured to move freely within a designated area and have the freedom and capability to alter its path within that area, for example, in response to sensed obstacles where a collision with such an obstacle may cause damage to the truck. In this case, the autonomous truck can be configured to avoid such a collision—as described in Chapter IV.

Autonomous haul trucks and other autonomous material handling units often include multiple modes of operation, which includes: an autonomous mode of operation whereby the vehicle functions autonomously; and an operator-controlled mode of operation whereby a human operator can manually control the vehicle. Operator controlled mode of operation includes: a remote-controlled mode whereby an operator controls the vehicle from a remote location; and an onboard mode whereby an operator is present on or in the vehicle in order to manually control the vehicle.

It will be appreciated that a vehicle, such as a haul truck, that is able to function in autonomous mode of operation is referred to as an autonomous vehicle, even though such vehicles can function non-autonomously (that is, manually controlled by a human operator).

An autonomous vehicle having multiple modes of operation is able to switch between those modes of operation as required or desired. The switching of modes can occur automatically or remotely. For example, when an autonomous vehicle identifies a circumstance where human intervention is required, it is able to switch to operator-controlled mode with a default idle state and alert an operator to take control of the vehicle. It will also be appreciated that certain circumstance may warrant an automatic switching to autonomous mode from manual mode. For example, a vehicle that is being manually operated in operator-controlled mode could sense the operator approaching a hazardous area such as a sheer drop and the vehicle may alert the operator as well as switch to autonomous mode to move the vehicle away from the hazardous area. The switching of modes can also occur manually. For example, an operator may observe a certain situation whilst a vehicle is in autonomous mode and wish to take immediate manual action so the operator can switch from autonomous mode to operator-controlled mode to complete that action and then the operator can switch the vehicle back from operator-controlled mode to autonomous mode so that the autonomous actions can continue.

Wireless communication between devices is by any appropriate standard or proprietary hardware and communications protocols, for example infrared, Bluetooth, WiFi; near field communications (NFC); Global System for Mobile Communications (GSM), Enhanced Data GSM Environment (EDGE), long term evolution (LTE), code division multiple access (CDMA—and/or variants thereof such as wideband CDMA), and/or any other possible wireless hardware/connectivity protocol.

In various embodiments, the payload capacity of each of haul truck 16 is determined by the sensing device 208 (in terms of how much of raw material 210 is loaded) and/or a dedicated sensor on each of haul truck 16.

It will be appreciated that in other embodiments, one or more of haul trucks 16 are manually operated haul trucks.

As best illustrated in FIG. 16, blast site 204 is a blasted mine bench, that is, where the site where an explosive blast takes place and/or where the broken up (blasted) raw material 210 settles following the blast. It is noted that a mine bench is divided up into a plurality of bench “grade blocks”, those blocks being sub regions of the bench. These blocks may be demarcated based on a number of factors, including the area size, the volume of anticipated raw material 122 following a blast, and the grading of raw material 122. Typically, a mine bench is 10 metres or more in both height and bench block size to accommodate large ultra-class haul trucks. However, where conventional sized haul trucks are utilized, the mine height and bench block size can be in the range of 2.5 to 10 metres or more preferably 5 to 10 metres. Furthermore, typically, the width of a bench is generally 70 metres or more in order to accommodate large ultra-class haul trucks. However, where conventional sized haul trucks are utilized, the width can be in the range of 20 to 70 metres or more preferable 40 to 60 metres. Additionally, the smaller width of the bench also allows for an overall steeper mine face profile, which would allow for mining deeper.

It will be appreciated that a pit is the entirety of the area from which ground has been excavated, and includes roads and walls, amongst others. The pit has dedicated entrance and exit points and, further the pit has a pit floor, which is the bottom of the pit. Blast site 204 is located within the pit floor. However, in other embodiments, blast site 204 is located within the pit, but not within the pit floor.

Raw material 210 is categorised based on a grading of the material which is influenced by the concentration of valuable material within a given volume of raw material 210, in other words the concentration of target metal/mineral in the ore. For example, if iron is the desired material/target metal, if the sensed raw material 210 (ore) is found to have 70% iron mineralisation, it will be graded and then categorised appropriately based on this sensed concentration of iron.

Raw material 210 will also have a quality characteristic whereby the quality is influenced by the amount or concentration of other undesirable or deleterious material within a given volume of raw material 210, in other words the concentration of non-target minerals/elements in the ore. For example, in the case of iron ore, the quality of raw material 210 will be affected by the amount of phosphor. For example, a given volume of raw material 210, say iron ore, could be of a high grade in terms of concentration of iron but also of a low quality due to its concentration of phosphor. Similarly, for the example of coal, where a given volume of raw material 210 could be of a high grade in terms of coal content but is also of a low quality due to its concentration of ash. In other embodiments, the categorisation of raw material 210 is affected by the concentration of undesirable or deleterious substances in a given volume of raw material 210. In the example of iron ore mining and processing, such deleterious material includes materials such as phosphor and sulphur, which will negatively affect processing methods and processing equipment. It will be appreciated that material that has a relatively low quality can be blended with material with a higher quality in order to increase the overall quality of a total volume of raw material 210 so that is it at or above a tolerable quality threshold. Such a blending process can occur at the time of loading a truck, for example, a truck will receive material from loading device 212 where a certain amount is of a relatively low quality and a certain amount is of a higher quality. The blending process can also occur at second location 206 where a specific dumping location can receive dumped material of a relatively low quality from one or more of haulage truck 16 and dumped material of a higher quality from other one of haulage trucks 16 such that the combined average quality is above a tolerable quality threshold. Similarly, it will also be appreciated that blending can be performed in a similar manner to achieve a desired target grade of material. Material can also be screened, bulk sorted or partially sorted to increase grade.

Further, in embodiments, the categorisation of raw material 210 will also be influenced by the physical properties of the raw material 210. For example, material can be dry or clayish depending on its moisture content, where an overly clayish material is undesirable due to its proclivity to clog up mining equipment. As such, there will generally be a minimum threshold of clayishness that is tolerable and will not significantly exacerbate the clogging of mining equipment. It will be appreciated that material that has a clayishness that is over the tolerable threshold are often blended with relatively dry material in order to reduce the overall clayishness so that is it at or below the tolerable threshold. Such a blending process can occur at the time of loading a truck, for example, a truck will receive material from loading device 212 where some is of a clayish nature and some is of a dry nature. The blending process can also occur at second location 206 where a specific dumping location can receive dumped material of a clayish nature from one of haul trucks 16 and dumped material of a dry nature from another one of haul trucks 16. Another important physical property of the raw material 210 that, in embodiments, is taken into consideration in regard to categorisation is fragmentation, that is the material being a small enough fragment size that is convenient to transport and process. Larger fragment sizes are often processed, for example, by a crusher in order to reduce the fragment size.

Within system 200, raw material 210 is categorised into three categories:
1) High grade material—that being material that is of a quality that is ready for processing such as sizing and/or concentration processes;
2) Low grade material—that being material that is of a quality in which pre-processing activities must be applied to the material in order to convert it to high grade material; and
3) Waste material—that being material that is uneconomical to recover, i.e. it is unsalvageable and entirely unfit for processing (which could be due to low levels of desired material, very high levels of deleterious materials, or a combination of both).

Second location 206 is generally a stockpile or other processing site. However, it will be appreciated that second location 208, in various embodiments, will refer to a plurality of sublocations within or external to a mine site. In such embodiments, each of the plurality of sublocations will only receive raw material 210 of a certain predefined material category. For example, in a preferred embodiment, second location 206 includes three sublocations: 1) a high grade material stockpile for the high grade category material, which may include a train loading dock 20 for transferring the high grade material to a processing plant 30 or shipping port 24 as shown in FIG. 2; 2) low grade material stockpile for the low grade category material which may be a storage dump (as shown in FIG. 2) or include in itself, pre-processing equipment (noting that, practically speaking, such low grade material could be built up and remain for decades before pre-processing, given the majority of resources will be allocated to the higher grade material); 3) a waste dump for waste category material.

In embodiments, the low-grade material stockpile includes a separating and/or concentration pre-processing equipment, which may be referred to as a pre-processing plant on the mine site. In other embodiments, blast site 204 will include in-pit operations such as in pit crushers, sizers or sorters which provide an early processing before the material is loaded into haulage trucks 16. In practical terms, the in-pit operations may be up to 2 km to 4 km from the initial location of raw material 210, and such in-pit operations are applicable to both high grade material and low-grade material. For example, a crusher is used to break up high grade material even further that that caused by the blast, if size is an issue in respect of transportation and/or processing.

In yet other embodiments, material categories will differ from the above three categories. For example, in one embodiment, these are two material categories: waste material; and non-waste material. In another embodiment, there is a fourth material category in addition to the preferred three categories, that being a middle grade material category. In yet other embodiments, each of the preferred three categories may be divided into further subcategories depending on size such that larger sized material will go through an additional process to reduce the size (for example, through use of a crusher). In yet other embodiments, each of the preferred three material categories may be divided into further subcategories depending on dryness/clayishness such that each of the three material categories material will be subcategorized into dry or clayish. It will be appreciated that the specific categories chosen will depend on processing requirements such that each category relates to a considered material extraction process, that is, any category could be chosen if the mine site/plant is able to or has in place a process for that grade or quality of material.

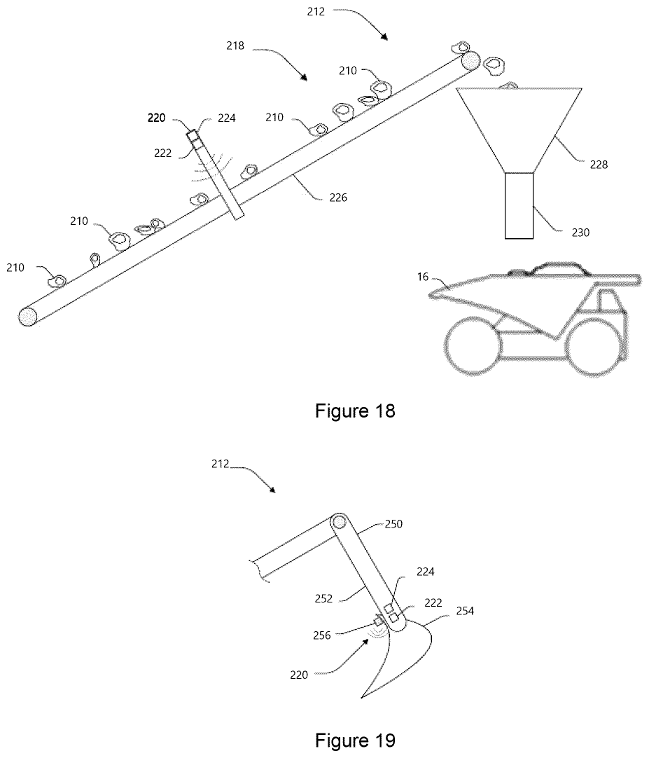

Referring to FIGS. 18 and 19, loading system (which includes loading device 212) includes one or more pieces of equipment (which are individual loading devices akin to the loading device 212) suitable for loading raw material 210 into the open-box cargo beds of the haulage truck 16. In embodiments where haul trucks 16 have flat beds or chassis that are configured to transport one or more cargo containers (described as “haulage trucks” in Chapter VI) loading device 212 is equally suitable to loading containers that are transportable by haul trucks. Such one or more pieces of equipment includes, in various embodiments, excavators, dozers/loaders, face shovels, rope shovels, and conveyor loaders. In some embodiments, loading device 212 will be manually operated, but in other preferred embodiments such as FIG. 18 where loading device 212 including a conveyor loader 218, loading device 212 is automated and does not require manual control (other than to activate the conveyor loader). In yet other embodiments, loading device 212 will include a plurality of pieces of equipment where some are manually operated, and some are automated. For example, loading device 212 could include a manually operated excavator for moving raw material 210 from blast site 204 to an automated conveyor loader 218 which in turn loads raw material 210 into one or more of haul trucks 16.

Referring to FIGS. 18 and 19, sensing device 220 is either mounted to (that is, retrofitted to) loading device 212 or integrally formed with loading device 212. Sensing device 220 includes a sensor processor 222 for processing the sensed information in order to grade raw material 210 and thereby determining the material category of raw material 210. Sensing device 220 also includes a sensor communications unit 224 coupled to sensor processor 222 for providing wireless communication (as explained above) with, amongst others, vehicle communications unit 216 of each of haul truck 16.

The conveyor loader 218 is essentially a feeder for feeding material into trucks. Conveyor loader 218 receives material from a shovelling device such as an excavator and direct the material towards and load the material into a waiting truck, thereby acting as an intermediary between the shovelling device and truck to alleviate the burden of directly loading the truck from the shovelling device. Loading mined material from the shovelling device into truck often results in a variable fill factor due to inconsistencies in the fill volume of material in the bucket of the shovelling device. This leads to unpredictable and irregular loading. The conveyor loader 218 greatly improves the predictability and efficiency of loading by dispensing the correct amount of mined material into the haul truck each time.

Referring to FIG. 18, conveyor loader 218 includes a conveyor belt 226 and a hopper 230 wherein conveyor belt 226 transfers raw material 210 to hopper 228 which funnels raw material 210 into one of the plurality of haul trucks 16. Sensing device 220 is positioned such that it senses chemical properties of raw material 210 on conveyor belt 226. In this embodiment, sensing device 220 is also configured to control conveyor loader 218 such that it will automatically activate and deactivate conveyor belt 226 as required (more on this below), or open and close a chute 230 of hopper 228 to respectively allow or prevent loading. In embodiments, conveyor loader 218 includes a diverter and multiple conveyor belts and hoppers such that raw material 210 is sensed on a first conveyor belt and then a diverter is used to divert material to different hoppers and/or conveyor belts based on the determined category of raw material 210 for subsequent loading into different ones of haul truck 16.

In other embodiments, conveyor loader 218 can be replaced by any buffer device that, within the process stream, sits between loading device 212 and haulage truck 16. Such buffer devices take the form of any piece of machinery that is aimed at efficiently receiving raw material from loading device 212 and feeding it into haulage truck 16, for example MMD's Surge Loader®. In embodiments, like conveyor loader 218, the buffer device includes sensory logic such that the buffer device is a material buffer with material selection and diversion capability. Like conveyor loader 218, the material buffer is informed by material property sensing devices and associated computer processing of any sensed material properties. Buffer devices such as conveyor loader 218 are able to:
Carry or transport material a distance before ultimately loading it into haul truck 16, such a distance being anywhere within the range of a few metres up to 100 metres or more, for example, to the edge of a pit or via angle conveyors to higher levels in a mine;
Hold a certain amount of material, so that material can be loaded onto the buffer device without having to immediately have to unload some material into a truck, for example, buffer devices hold three to four truckloads of material while waiting for a truck to arrive thereby allowing time for trucks to arrive and/or allowing for a loaded truck to depart and an empty truck to arrive without stopping the loading of the buffer device; and
Provide the benefit of decoupling two processes (unloading and loading), thereby removing the dependency between one action (unloading of loader) and the other (loading into truck).

Referring to FIG. 19, in other embodiments where loading device 212 includes an excavator 250, only partially illustrated showing a distal end of an arm 252 which is attached to a bucket 254, (or other loader with a similar bucket loading component) sensing device 120 takes the form of a bucket sensor 256 for sensing each load of raw material 210 that is picked up by excavator 250. In other embodiments, where loading device 212 includes both excavator 250 and conveyor loader 218, only the sensing device 220 on the conveyor loader 218 is used to sense and categorise raw material 210 after it has been loaded onto conveyor belt 228 by excavator 250. In other embodiments where loading device 212 includes both excavator 250 and conveyor loader 218, bucket sensor 256 is used to sense and categorise raw material 210 whilst it is loading it onto conveyor belt 226.

Sensing device 220 includes one or more sensors with the type of sensor including PGNAA (Prompt Gamma Neutron Activation Analysis) sensors, microwave sensors, x-ray sensors, and magnetic induction sensors, amongst others. Sensing device 220 senses the chemical properties of raw material 210 to ascertain the amount of desired (for example, iron mineralisation in rock), undesired material (for example, phosphor, sulphur content etc.) and physical properties (for example, fragmentation size, moisture content etc.)

Sensing device 220 is configured to sense the concentration of desired material referred to as (for example, iron, coal, etc.) in raw material 210. For example, if the desired material is iron, sensing device 220 is configured to sense the concentration of iron mineralisation in raw material 210. As will be appreciated by those skilled in the art, the term “grade” as used in relation to, for example, a “metal-containing material” is understood herein to be a term that is dependent on currently available technology and the current price of the particular metal, and that material currently considered “low grade” may be considered valuable material in the future depending on technological developments and the future price of the metal.

In alternate embodiments, sensing device 220 is configured to sense either the concentration of desired material or the concentration of deleterious material. In yet other embodiments where sensing device includes multiple sensors, for example the bucket sensor and the sensor on conveyor belt 226, one of those will sense the concentration of desired material and the other will sense the concentration of deleterious material.

In various embodiments, various sensing methodologies (and combination thereof) are be used to obtain knowledge of material properties both during and after drilling, and during excavation. In these and other embodiments, the material category is estimated based on knowledge of the bench of blast site 204 obtained prior to blasting. Examples include:
a. Measurement-while-drilling (MWD) data that will be obtained during a blast hole drilling process which, along with other tools and further extrapolation techniques, will provide concentration of desired and/or undesired materials in each block of the bench, in order for each block to be designated a material category;
b. Blast cone sampling; and
c. hyperspectral imaging, where techniques of which are discussed in more detail in the following patent publications: PCT publication WO2016/112430 entitled “Hyperspectral Imager Method and Apparatus” published on 21 Jul. 2016; PCT publication WO2011/094818 entitled “Determination of Rock Types by Spectral Scanning” published on 11 Aug. 2011; and Australian patent 2009200859 entitled “Scanning System for 3D Mineralogy Modelling” published on 24 Sep. 2009.

A mineral deposit can be described as being an aggregate of that mineral within an ore body in a higher concentration than is usual for the ore body. For example, the minerals may form localised areas such as seams or discrete pockets, as in the case of iron ore and gold deposits, but not limited thereto. The material within an ore body that does not contain the mineral of interest is referred to as waste. When mining larger parcels of material, dilution occurs across ore and waste boundaries. Consequently, the volume of ore, being solid material from which a valuable metal or mineral can be extracted, relative to waste is reduced.

Ore body knowledge (OBK) is the integration of geological, mining, metallurgical, environmental, and economic information to create geological models for use in mining. Such models are used to identify rich deposits of minerals and to evaluate the case and cost of mining deposits within a given area. Advanced OBK prior to blasting can be used to identify target areas of higher economic value, such as through higher mineral concentration, greater case of access, or a combination thereof. For example, initial ore identification and grade estimation obtained using exploratory data and modelling can be updated using production data, such as measurement while drilling (MWD) data, blast cone sampling, hyperspectral imaging, and the like. More advanced geological maps enable the identification of specific areas of a mine to be targeted.

Smaller benches, combined with advanced OBK, can allow for more specific areas of a mine to be targeted. Smaller haul trucks, such as RSATs described in Chapter II. can access those specific areas and obtain less dilute, or in other words more homogenous, payloads (e.g., payloads that are predominantly of one grade, such as high grade). Mining can therefore be more selective, load by load. The use of smaller benches, tighter blasts in targeted areas of a mine, and more selective payloads may result in the overall processing and output of the mine being a higher resolution than traditional surface mining using ultra-class haul trucks.

Additionally, smaller benches and the use of RSATs can mean that smaller block sizes are feasible, which may also allow for more selective mining. Parcels of blasted material are referred to as blocks and block sizes depend on the size of the bench and the design of the blast. The quality of each block is classified based on the percentage of ore contained in the respective block. Block sizes may be for example, 10 m×10 m×10 m or 5 m×5 m×5 m or 2.5 m×2.5 m×2.5 m. In one example, a 10 m×10 m×10 m block that contains 40% ore is classified as relatively low grade. However, dividing such a block into 8 blocks of size 5 m×5 m×5 m may yield 4 blocks of 70% ore, 2 blocks of low grade, and 2 blocks of waste material.

Whilst each block is categorised, after blasting of adjacent blocks, the boundaries of those adjacent blocks will contain blasted material from each of the two adjacent blocks. Therefore, the categorisation of material disposed at those boundaries will be a mix of the categories of the adjacent blocks and, which may present an issue in cases where the categories of the adjacent blocks are different. In such scenarios, both pre-sensing prior to blasting for material of a block that is a sufficient distance from the boundary and active sensing following blasting during the loading process for material of at or within a certain distance of the boundary is used so that the more uncertain raw material 210 at the boundary is actively sensed as the category could be that of either adjacent block and this will almost certainly vary through the raw material at the boundary. As such, this ensures accuracy of categorisation of all raw material 210 include that at the boundary of adjacent blocks.

Post-blast, there are also techniques that can be used to distinguish between blasted material of different types, for example different grades such as high grade and low grade or different material types. For example, hyperspectral imaging, or loading device (e.g., excavator, shovel) sensors can be utilised to analyse blasted material. Loading device sensors may utilise, for example, one or more of a Prompt Gamma Neutron Activation Analysis (PGNAA) sensor; a microwave sensor; an x ray sensor; and a magnetic induction sensor. Such techniques can also be used to load trucks with blasted material of predominantly one grade.

In some embodiments, identification of an area of interest is based on advanced ore grade information. Initial ore grade information may be obtained through exploration data. Such exploration data is obtained through exploratory drilling, geological modelling, and the like. The initial ore grade information is updated to provide pre-blasting ore grade information based on one or more of: OBK through MWD data obtained from the mining site or a nearby site, blast cone/drill chip sampling, hyperspectral scanning, and the like. The blasted material is optionally sorted into classification grades. Sorted material can then be loaded into different haulage trucks. For example, if the blasted material is simply sorted into high grade and low grade ore, then high grade ore is loaded into a first truck and low grade ore is loaded into a second truck. This allows the high grade ore and low grade ore to be directed to different stockpiles for different processing. Sorting of the blasted material may be based, for example, on hyperspectral imaging, magnetic induction, or loading device (e.g., excavator, shovel) sensors for analysing blasted material. Loading device sensors may utilise, for example, one or more of a Prompt Gamma Neutron Activation Analysis (PGNAA) sensor; a microwave sensor; an x ray sensor; and a magnetic induction sensor.

Sensing device 220 is also in communication, via sensor communications unit 224 with the central controller of mine site. In various embodiments, sensor communications unit 224 communicates directly with vehicle communications unit 216 or must communicate with vehicle communications unit 216 via the central controller of mine site 202. In preferred embodiments, sensor processor 222 will instruct a specific one of haulage truck 16 to proceed to a specific second location 206 based on the category of raw material 210 determined by sensor processor 222 that is loaded into that specific one of haulage truck 16.

In some embodiments, sensing device 120 is configured to sense raw material 210 and communicate that raw sensed data to the central controller of mine site 104 where it is processed in order to grade raw material 210 and thereby determining the material category of raw material 210. Based on the determined material category, the central controller of mine site 202 will then instruct a specific one of haul truck 16 to proceed to a specific second location 206 based on the category of raw material 210 (determined by the central controller of mine site 202) that is loaded into that specific one of haulage trucks 16. In yet other embodiments, the central controller of mine site 202 will communicate the determined material category to controller 214 of a specific one of haulage truck 16. Controller 214 will then, based on the determined material category, instruct that specific one of haul truck 16 to proceed to a specific second location 206 based on the category of raw material 210 that is loaded into that specific one of haulage truck 16.

In embodiments where sensor communications unit 128 communicates with vehicle communications unit 216 via the central controller of mine site 202, a haul truck is able to commence travel away from blast site 204 in the general direction of second location 206 (in reality, there may be only one predefined route to travel) and the specific second location 206 based on the category of raw material 210 that is loaded into that specific one of haul trucks 16 can be determined en route as the distance and route between blast site 204 and second location 206 will be such that providing instructions en route will not at all delay the transportation of raw material 210 in haul trucks 16. In this case, the material category is generally determined by sensor processor 222 so that a single category of raw material 210 is loaded into any one of haul trucks 16.

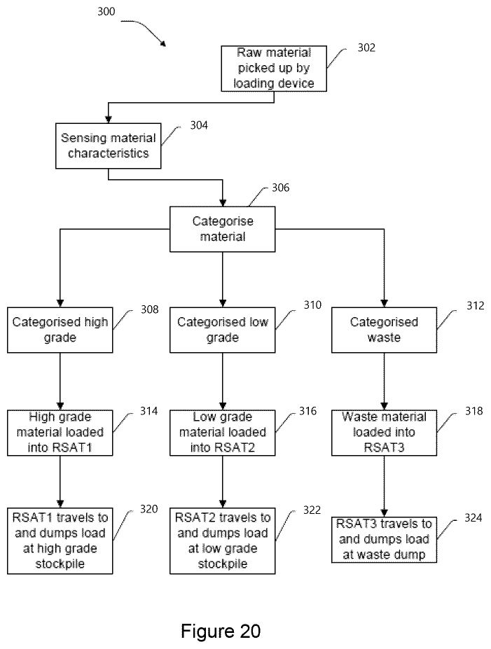

Referring to FIG. 20, there is illustrated a process for categorising, loading and transporting raw material 210, the process denoted by reference 300. At 302, loading device 212 picks up raw material 210 from blast site 204. At 304, whilst raw material 304 is held by loading device 212, sensing device 220 actively senses characteristics of raw blasted mined material 210. At 306, sensor processor 222 categorises raw material 210, based on the sensed characteristics, into one of the following material categories: high grade material at 308; low grade material at 310; and waste material at 312. It will be appreciated that at 306, in some embodiments, sensing device 220 also determines other chemical properties of raw material 210 such as dryness/clayishness and concentration of deleterious materials.

Based on that categorisation, each of haul trucks 16 will be loaded such that each individual vehicle only carries raw material 210 of one material category, denoted by references 314, 316 and 318 which respectively denote loading separate haul trucks 16, labelled in FIG. 20 as RSAT1, RSAT2 and RSAT3 with high grade material, low grade material, and waste material, respectively. It will be appreciated that each of empty haulage trucks 16 (RSAT1, RSAT2 and RSAT3) could be loaded with any single material category of raw material 210, but for illustrative purposes only, each of RSAT1, RSAT2 and RSAT3 is respectively loaded with high grade material, low grade material, and waste material. Practically speaking, any one of haul trucks 16 is loaded with whatever category of raw material 210 is in loading device 212 at the time the mine vehicle is ready to receive the material.

It will be appreciated that, in preferred embodiments, the loading of haul trucks 16 is not influenced by sensed dryness/clayishness and concentration of deleterious materials. However, these properties are recorded for each load within each of haul truck 16 for future purposes, for example, including formulating a “map” of second location 206 of precise locations where loads are dumped. For example, a certain sub-area of second location 206 (say, the north side) is dumped with a certain category with certain quality properties, such as high-phosphor, low-clay material, and another certain sub-area of second location 206 (say, the south side) is dumped with another certain category with certain quality properties, such as high-phosphor, high-clay material.

In alternate embodiments, each of haul truck 16 is preassigned to receive a specific material category of raw material 210, that being RSAT1 preassigned to high grade material, RSAT2 preassigned to low grade material and RSAT3 preassigned to waste material. Further, sensor communications unit 224 will communicate directly with vehicle communications unit 216 of each of haul trucks 16 to instruct them to proceed to a specific second location 206 based on the material category of each haul truck's load of raw material 210.

It will be appreciated that, as each individual haul truck 16 is only loaded with raw material 210 of a single material category, this may mean that one or more of haul trucks 16 is not completely filled up if the volume of raw material 210 of a certain material category is less than the full capacity of a haul truck 16. Each of haul trucks 16 will set off from blast site 204 either when it has been filled to full capacity or when the raw material 210 being loaded changes to a different material category. For example, in the embodiment of FIG. 18, sensing device 220 on conveyor loader 218 will sense raw material 210 on conveyor belt 226 and whilst raw material 210 is the same material category and haul truck 16 is not at full capacity, conveyor belt 226 will continue transfer raw material 210 to hopper 228 to load haulage truck 16. However, once sensing device 220 determines that the material category changes or once that haul truck 16 has reached full capacity, sensor processor 222 will instruct conveyor belt 226 to deactivate until haulage truck 16 has moved from under hopper 228 away from blast site 204 and the next empty haulage truck 16 positions itself under hopper 228 after which conveyor belt 226 is activated and the loading commences into that next haul truck 16. In other words, the loading of one of haul trucks 16 is stopped when the material category changes (in the case of loading from hopper 228 already containing material, loading is stopped after an estimate of when the change in material category would occur) or when that one of haul trucks 16 is full. In embodiments using chute 230, the chute is opened or closed to effect the cutting off of the loading operation. For example, if hopper 228 is currently one third full and a change in material categorisation is detected by sensing device 220, if sensing device 220 is positioned halfway along conveyor belt 226 that feeds hopper 228 (and the density of raw material 210 along the half of conveyor belt 226 downstream of sensing device 220 is known), then chute 230 will be controlled to close once the raw material 210 in the third of hopper 228 and the additional raw material 210 on the downstream half of conveyor belt 226, has been loaded into one of haul trucks 16.

It will be appreciated that in some cases, it may not be feasible to deactivate conveyor belt 226 given that this may also necessitate, for example, stopping excavator 250 from loading material onto conveyor loader 218. As such, the use of toggling the opening and closing of chute 230 is preferable in taking advantage of conveyor loader 218 as a buffer to enhance efficiency of the overall loading process.

In some embodiments, two or more of RSAT1, RSAT2 and RSAT3 are loaded simultaneously or substantially simultaneously with their respective one of high grade material, low grade material, and/or waste material. For example, in an embodiment where

RSAT1 and RSAT2 are loaded simultaneously, RSAT1 and RSAT2 position themselves to receive raw material from their own predefined one of two hoppers and conveyor belt 226 includes a diverting mechanism that is configured to divert material of a certain grade to the desired hopper such that high grade material will be diverted to the hopper where RSAT1 receives that material and low grade material will be diverted to the hopper where RSAT2 receives that material. In yet other embodiments, there are two hoppers such that high and low-grade material is diverted by a diverting mechanism to one hopper where RSAT1 or RSAT2 are positioned to receive their respective high and low-grade material (at different times, not simultaneously) and the waste material is diverted to the other hopper 228 for discarding onto the ground where it is subsequently dozed. In this embodiment, the other hopper that receives the waste material may be spaced apart from the hopper 228 that directs the high and low-grade material respectively into RSAT1 and RSAT2 so that the discarded waste material is dumped at a distance that does not affect RSAT1 and RSAT2. In yet other embodiments where two or more RSATs carry the same category of material, a diverter can be used to simultaneously load multiple trucks with the same category of material.

After haul truck 16 sets off from blast site 204, at 320, haul truck 16 carrying high grade material travels to its specific second location 206, in this case a stockpile for a train loading dock, and dumps its load of raw material 210 at its specific second location 206. At 322, haul truck 16 carrying low grade material travels to its specific second location 206, in this case a stockpile for a pre-processing plant, and dumps its load of raw material 210 at its specific second location 206. At 324, haul truck 16 carrying waste material travels to its specific second location 206, in this case a waste dumping ground, and dumps its load of raw material 210 at its specific second location 206. It will be appreciated that, following 320, 322 and 324, controller 214 will inform central controller of mine site 202 that the load of raw material 210 of its category has been dumped, whereby central controller of mine site 202 can then update the “map” of second location 206, that is, update characteristics of the stockpile such as volume, mineral properties, etc.

It will be appreciated that a number of optional steps are included in other embodiments, including:
Prior to 302, a crusher is utilised for fragmentation of raw material 210 so that it is better suited to efficient transportation and/or efficient processing. Similarly, a sorter is utilised to sort pieces of raw material 210 by size such that pieces of a certain size or less are prioritised for loading onto haul trucks 16.
Following high grade material at 308, low grade material at 310, and waste material at 312, respectively subcategorising these into dry and clayish and, following this subcategorising blending of dry and clayish materials at a predefined ratio so as to produce material of a tolerable dryness/clayishness.

### Advantages of Detailed Embodiments

It will be appreciated that the embodiments of material categorisation and transportation system 200 described herein are advantageous over known systems as it achieves the following advantages:
Allows for partial loading of haul trucks 16, where in conventional systems involving the use of ultra-class haul trucks, the partial loading of a truck is not considered because each truck load represents a substantial percentage of the overall volume of material transported. Thus, partially loading an ultra-class haul truck would noticeably reduce the overall volume of material transported and, hence, the efficiency of each truck. In contrast, by using a large fleet of RSATs as haul trucks 16, the partial loading of a single RSAT so as not to dilute/contaminate its load represents a negligible impact on overall volume of material transported. As such, the use of partially loaded smaller haul trucks becomes economically feasible because the “lost opportunity” of partially loading one out of a large multitude of smaller haul trucks is much less than that of partially loading one out of a very small number of ultra-class haul trucks.
Even if the load of one RSAT haul truck happens to be diluted and/or contaminated, the magnitude of this dilution and/or contamination is restricted to just that one RSAT's load-volume, which is significantly smaller than the load-volume of an ultra-class haul truck.
Whilst one ultra-class haul truck can carry the equivalent of two to six RSATs, in terms of cost, one ultra-class haul truck is far more expensive to purchase, run and maintain than two to three RSATs. This is due to RSATs being of a conventional size and therefore only requiring easily attainable conventional parts and conventional maintenance facilities. On the other hand, ultra-class haul trucks require bespoke spare parts that are much more difficult to obtain, and bespoke facilities and equipment for running and maintenance.
The use of RSATs that have a greater range than ultra-class haul trucks will allow for different and more efficient mine layouts. For example, for a mine site having multiple pits, instead of each pit having its own dedicated stockpile that is within a certain limited range of the pit (that range based on the maximum safe range of ultra-class haul trucks) the mine site could have a single central stockpile at a greater distance from each pit where all material is consolidated. Similarly, a mine site having multiple pits could also be arranged so that there is a single processing facility and/or outbound logistical facility (such as trains).
The use of RSATs over ultra-class trucks may enable access to more areas of a mine site. In other words, the small sized vehicle may be able to access areas of the mine site (such as remnant areas) which would otherwise be inaccessible for ultra-class trucks due to their significantly greater size. Expressed in another way, by using RSAT's we can now mine more ore of the deposit economically and mine more selectively. So, it is now possible to mine material that may be otherwise have been left behind.
Improved discrimination between high and low grade blasted material by using smaller sized haul trucks which naturally results in less dilution and/or mixing of high grade, low grade and waste material. Since ultra-class haul trucks must be completely filled in order to facilitate transport efficiencies, a call must be made on the grading of the material of the entire load which will limit the accuracy of that overall grading given the great amount of material and the potential need to load a single ultra-class haul truck with materials of different gradings. The use of RSATs that do not need to be completely filled will not force such a call to be made as the loading of a truck will simple cease when there is no more material of a certain material category to load. This provides an improved resolution of payloads which in turn provides a higher resolution of stockpiles with little dilution and much lower chance of non-waste material being graded as waste material.
Dynamic re-direction of loads in smaller trucks to different destinations based on chemical properties of the load. This is possible due to the chemical properties being sensed by sensing device 220, and further because the small loads of each haul truck 16 means that the properties of each truck load are more homogenous (and hence meaningful) as compared to the load of a much larger ultra-class haul truck.
Further, haul truck 16 can be redirected mid-journey which will be advantageous in certain circumstances, for example: if more information being processed that takes time, or information is processed offsite or remotely (such as a cloud model) and the result comes back to divert certain haul truck 16 to a different destination location; or information from one of haul truck 16 at another loading point influenced the target for another one of haul truck 16.
Sensing raw material 210 at the time of excavation and/or loading enables material properties to be tracked per load with an external data system (which would be in communication, via a network, to the central controller of mine site 202, sensor processor 222, and controller 214). Current stockpiles are a blend of many materials with limited knowledge of the chemical composition.
Having knowledge of material properties can be used to decide on how stockpiles are built. That is, by digitally tracking where each truck load is dumped and recording the material properties that are measure by system 200 at the excavation process for each load, a digital “map” of the stockpile can be constructed. When the stockpile is reclaimed, this map is used to select a specific sequence and/or target specific chemical and physical properties to optimise blending and/or productivity of the plants.
A range of smaller stockpiles can be built, which can pre-sort raw material 210 based on certain chemical and physical properties (for example, low phosphorous, low silica, fragmentation etc.) thereby producing a range of stockpiles that form a material “menu” where specific material can be picked as needed at a processing plant or for a down-stream process.
There is a minimisation of wastage which is particularly important given that, over time, the general quality of ore has reduced significantly and therefore minimising wastage is becoming more important than ever. It is noted that conventional systems using ultra-class haul trucks (that require use of full truck capacity and potentially a number of trucks in a relay type arrangement to carry a single load cover longer distances) are much more susceptible to wastage due to necessary rehandling.
The use of RSATs as part of the system provides a complete autonomous system. From the sensing and resultant categorisation of the raw material to the transportation of the categorised material to the remote location (such as stockpiles, sorting facilities, crushing facilities, etc.), this can be done without the need for human intervention, noting that some human intervention can be accommodated. Furthermore, autonomous RSATs can be provided with a command to be redirected mid-journey which, again, could be carried out without human intervention.

As such, system 200 provides significant advantages and improvements over known systems in terms of accuracy of material grading and categorisation and minimisation of wastage.

### Chapter VI—Containerised Mining Operation

This chapter outlines an embodiment of a mining operation in which mined material can be loaded into containers 26 and transported from the mine site, i.e. pit 12, to another location, for example a stockpile, i.e. container storage facility 28, mineral processing plant 30, railway 20, or shipping port 24.

Containers 26 loaded with mined material or processed mined material can be picked up and placed on a “movable unit” or coupled to a “moving unit” and transported on the unit between locations and then removed from the unit with a payload of material in the unit is a departure from the conventional use of haul trucks and LHDs in open cut and underground mines in which the “movable unit” and the storage tray for mined material are in a single integrated unit.

The term “moving unit” should be read as a noun. In other words, the term “moving” in the term “moving unit” is not to be read as a verb. The “moving unit” can be either be moving or stationary depending on its use.

A “movable unit” is a unit that is not limited to movement along a particular path. On the other hand, a “moving unit” is a unit that is limited to movement along a particular path, for example defined by rails or guides.

The use of the containers 26 in the mining operation also provides an opportunity to stockpile mined material or a processed mined material in the containers in an intermodal, such a shipping port-like, storage and handling facility. This increases the options for mining operation schedulers in meeting customer orders.

An advantage of having a storage facility for containers of mined material located at the mine is that it negates the requirement for open stockpiles and their disadvantages.

Open stockpiles are open to the elements and therefore subject to material loss and dilution. Closed containers avoid such material loss and dilution due to the elements.

Conventionally, trucks are loaded from the open stock pile using excavator shovels. The volume of material and size of rocks contained in each shovel fluctuates between loads, also known as a variable fill factor, which results in unpredictable and irregular loading of trucks. Irregular loading of trucks contributes to reliability and maintenance issues with the trucks. As such, a stockpile of containers containing discrete loads improve the predictability and regularity of loading and consequently contribute to an improvement in fleet reliability and maintenance of trucks used to carry such containers.

Basically, the use of the containers 26 provides an opportunity to decouple the volume of material being transported within a mine and from a mine from the selection of the transportation options for carrying the material. The containers 26 provide an opportunity to transport a “unit” payload within and from a mine in the container. This is a significant shift from the approach of conventional mining. The use of the containers means that the “unit” payload is defined (and definable) even before it is transported, and it can continue to be defined (or definable) while in the containers as it is transported within and from the mine and at a shipping terminal.

The term “container” is understood herein to mean any container with mechanical properties that are suitable to withstand loading, handling and transporting mined material within a mine or from a mine.

One example of the container 26 is intermodal, such as a shipping container-sized, units which are configured to be top-filled.

The containers 26 may be typical shipping container-sized containers, such as:

| Container | Internal dimensions (L × W × H) | Cubic capacity | |
|---|---|---|---|
| 1. | 5.89 × 2.35 × 2.36 m | 33 | m³ |
| 2. | 5.89 × 2.35 × 2.69 m | 37 | m³ |
| 3. | 12.05 × 2.35 × 2.36 m | 66 | m³ |
| 4. | 12.05 × 2.35 × 2.69 m | 76 | m³ |

The containers 26 may be configured to carry any suitable payload.

Typically, the containers 26 may be configured to carry a payload of at least 10 tonnes and up to a maximum of 80 tonnes or more, typically 10-80 tonnes, with options of 30-70 tonnes, and 40-60 tonnes.

The containers 26 may be made from any suitable material or combination of materials.

By way of example, the containers 26 may be made from steel.

The floor, side walls and end walls of the containers 26 may be made from or include steel panels that are welded or otherwise connected together to form the containers.

The containers 26 may include a removable lid that, when positioned, closes the container. In use, the lid may be removed to allow mined material to be loaded therein by excavators and other loading vehicles/devices similar to how open tray trucks are conventionally loaded.

The containers 26 may include a lid that can be moved between a closed and an open position while remaining connected to a body of the containers.

The containers 26 may include a roof and an opening for top-filling the container by excavators and other loading vehicles/devices similar to how open tray trucks are conventionally loaded.

The containers 26 may be configured to be tiltable rearwardly to discharge mined material from the containers.

The containers 26 may be configured to be rotatable about a lengthwise extending axis to discharge mined material from the containers.

The containers 26 may include an outlet to bottom discharge mined material from the container, typically in the floor of the containers.

For example, the floor may include doors that can swing downwardly from a closed position to an open discharge position and then be closed for re-use of the containers 26 to receive more mined material.

The containers 26 may include container identification, including by way of example, data on the minerology and mass of a payload in the container at a given point in time. The container identification may include QR codes indicative of mineralogy, such as grade, quality (e.g. penalty elements, deleterious material, etc.).

By way of example, the containers 26 may be a rotatable container manufactured by Intermodal Solutions Group (ISG), such as described in Australian patent application 2021218002 in the name of Lock and Move Pty Ltd.

A closed container 26, once loaded, is carried by a “movable unit”, in this embodiment in the form of a haulage truck 16 configured to support the container 26, for example by providing a flatbed tray. This is a different vehicle to the haul truck 16 described in relation to FIG. 1.

The haulage truck 16 may have any suitable container mounting, i.e. locating, member.

The haulage truck 16 may include elements to releasably retain (i.e. secure) the container on the container mounting member and consequently on the haulage truck 16.

It is noted that the empty container 26 may have been transported into the pit 12 on the haul truck 16 or may have been already located in the pit 12 and loaded onto the flatbed tray haul truck 16 in the pit 12.

The “movable unit” may be an RSAT having a flatbed tray that is configured for carrying a container 26.

The “movable unit” may be any other suitable unit that is configured for carrying a container 26.

The haulage truck 16 transports the container 26 with the material payload along haul roads 18 from the pit 12 to the perimeter of the pit 12 up to an exit point at ground level.

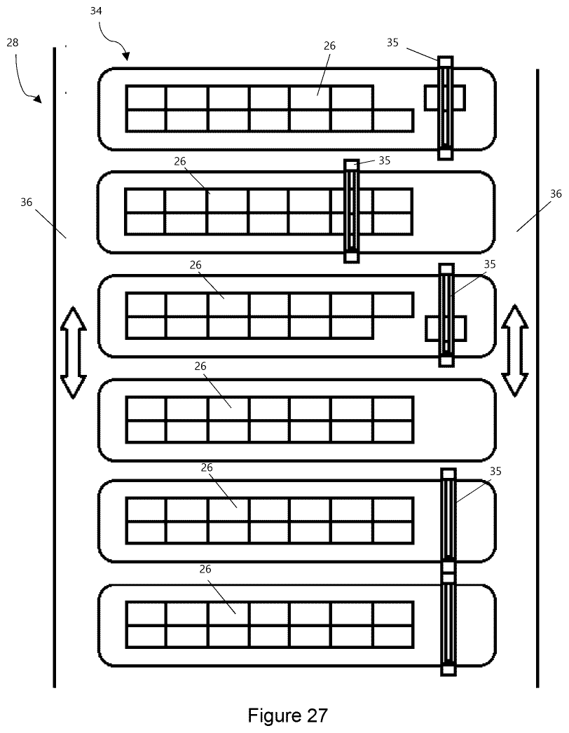

At ground level, one option (indicated by one of the arrows in the Figure) is for the haulage truck 16 to transport the container 26 along roads to a stockpile in the form of a container storage facility 28 where the container 26 with the material in the container is off-loaded from the flatbed tray haulage truck 16 and stored at the facility 28 and the haulage truck 16 picks up an empty container (not shown) from an empty container storage facility (not shown) and returns to the pit 12 to repeat the process. FIGS. 26 and 27 show an embodiment of the container storage facility 28.

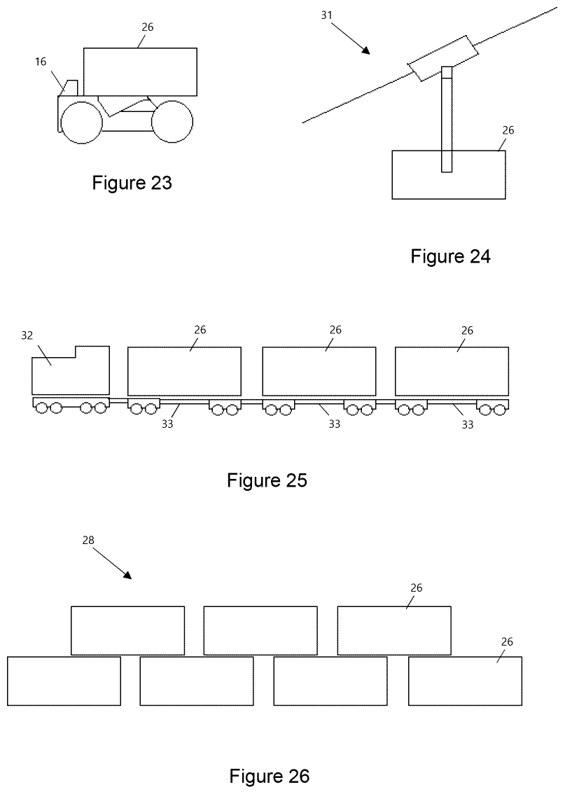

With further reference to FIG. 2, as required by mine scheduling, containers 26 stored at the storage facility 28 are loaded onto other flatbed tray haulage trucks 16 (an embodiment of which is shown in FIG. 23) and are transported to a mineral processing plant 30, at which the mined material in the containers 26 is off-loaded, for example into comminution units at the plant, and thereafter processed through the plant to upgrade the material. The upgraded material is transferred into containers 26 on flatbed tray haulage trucks 16 and (a) transported to and off-loaded and stored at the container storage facility 28 or (b) transported to and off-loaded onto flatbed railway carriages at a railway 20 and transported on the train to a shipping port 24.

The train with flatbed railway carriages is another embodiment of a “movable unit” in accordance with the invention. FIG. 7 shows an embodiment of the train with flatbed railway carriages.

With further reference to FIG. 2, as required by mine scheduling, loaded containers 26 stored at the storage facility 28 are loaded onto flatbed tray haulage trucks 16 (an embodiment of which is shown in FIG. 23) and are transported to and off-loaded onto flatbed railway carriages at the railway 20 and transported on the train to the shipping port 24.

With further reference to FIG. 2, another option is for the flatbed haulage trucks 16 to bypass the storage facility 28 altogether and transport the material along roads directly to the mineral processing plant 30 and off-load the material in the containers at the plant for processing in the plant.

With further reference to FIG. 2, another option (indicated by one of the arrows in the Figure) is for the flatbed haulage trucks 16 to transport the material along roads to the railway) at which the containers 26 are off-loaded onto railway carriages and are transported on the train to the shipping port 24.

Decisions to select any one of the above options can be made based on a range of factors, including the concentrations of key elements of material in the containers, the total weight of the material, the customer requirements, the available access to the mineral processing plant 30, the storage capacity at the storage facility 28, the storage capacity at shipping port 24, the capacity of blending facilities (not shown) at the shipping port 24, and the availability of material from other mines.

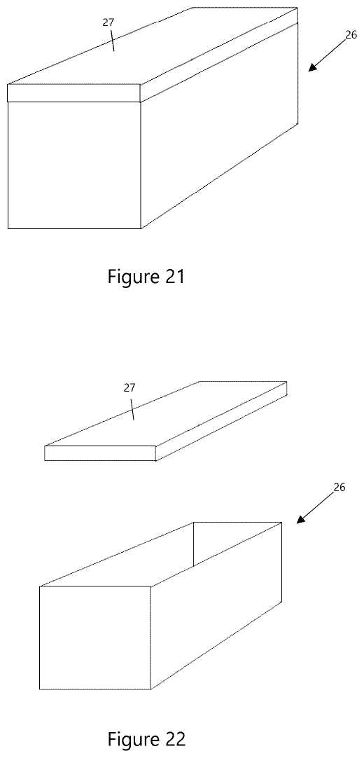

FIGS. 21 and 22 are perspective views of an embodiment of a container 26 with a lid 27 for use in the mine shown in FIG. 21. FIG. 22 shows the container 26 in a closed configuration with the lid 27 closing the container. FIG. 22 shows the container 26 in open configuration with the lid 27 removed from the container. Typically, the container 26 is configured to carry a payload of at least 10 tonnes and up to a maximum of 80 tonnes or more, typically 10-80 tonnes, with options of 30-70 tonnes, and 40-60 tonnes. The container 26 is a cuboid-shaped unit made from steel panels that are welded together, with a floor, a pair of upwardly extending opposed side walls, and a pair of upwardly extending opposed end walls. It is noted that the container 26 shown in FIGS. 21 and 22 is an embodiment amongst many possible embodiments of the container.

FIG. 23 shows an embodiment of the “movable unit” in the form of a conventionally-sized (as described above) flatbed haulage truck 16. The truck 16 may be configured to transport the container 26. The truck 16 may be an electric powered vehicle. One example of a truck 16 is a RSAT. The truck 16 may be any one or more of autonomously-operated, manually-operated, or semi-autonomously operated. The truck 16 may be a wheel-mounted that can move along a road. The truck 16 includes a retaining element (not shown) to releasably restrain, i.e. secure, the container on the flat-bed tray and consequently to the haulage truck 16. The use of a conventionally-sized flatbed haulage truck 16 makes it possible to construct more conventional roadways rather than those used currently in mines operating with large haulage trucks 16 carrying large payloads.

With reference to FIG. 24, instead of a “movable unit” such as the flatbed haulage truck 16, other embodiments of the invention operate with a “moving unit” in the form an overhead suspension unit 32, such as a ski-lift type unit, that is configured to support and transport the container 26 along a pathway between a loading location and an unloading location. FIG. 24 shows the overhead suspension unit 32 located at an incline, for example for the purpose of transporting suspended filled containers 26 out of the pit 12. It is noted that the invention also extends to embodiments where the overhead suspension unit 31 is horizontal.

In use, the containers 26 may be loaded with mined material while the containers 26 are on the ground and then lifted onto the overhead suspension unit 32. Alternatively, mined material may be loaded onto containers 26 while the containers 26 are on the overhead suspension unit 32.

Ski lifts have an advantage that the stored gravitational potential energy of the raised empty containers on the way down the lift can be converted to kinetic energy to assist in movement of the filled containers on the way up the lift. As such, energy can be conserved. In contrast, other than regenerative breaking, no energy is recouped by trucking empty containers down to the pit.

In one example, a ski-lift type arrangement picks up containers at a pit bottom from an RSAT and transports the material to a processing plant, where the material is tipped into a crusher. The empty container is then transported back into the pit and transferred onto the RSAT truck, which itself is driven to a dig face to pick up the next load.

It can be appreciated that in some embodiments, a combination of “movable units” (such as the flatbed haul truck 16) and “moving units” (such as the overhead suspension unit 32) may be used to transport material from the pit 12 and within and from the mine. For example, in these embodiments, the selections of “movable units” and “moving units” may be governed by the transport requirements in the pit 12, from the pit 12, and within and from the mine.

FIG. 25 illustrates a “movable unit” in the form of a train 32 and a series of interconnected flatbed carriages 33 with containers 26 located on the carriages 33.

FIGS. 26 and 27 illustrate an embodiment of the container storage facility 28.

FIG. 26 shows a plurality of the containers 26 stacked at the container storage facility 28.

FIG. 27 shows a layout of the container storage facility 28.

It can be appreciated that the layout is similar to that of a layout at a container shipping port.

The FIG. 27 layout includes:
(a) a plurality of parallel, rectangular container storage sections 34, with stacked containers 26 on the sections;
(b) a gantry crane 35 or any other suitable type of container transport unit configured to traverse each section 38 and deliver containers 26 to and pick-up containers 26 from the sections;
(c) roadways 36 providing access to the container storage facility 28 and to the sections 34.

The container storage facility 28 includes a container tracking and monitoring system. In an embodiment of the invention, this system is linked to a more extensive tracking and monitoring system that covers movement of containers 26 from the pit 12 through the mine and on the rail transport network and at the shipping port and which includes recording mineralogy data for the material in the containers 26.

In use, a flatbed haulage truck 16 carrying a container 26 filled with material can transport the container into the container storage facility 28, and one of the gantries 35 can pick-up and move the container 26 to a pre-selected location on the associated section 38. Similarly, as required, the gantry crane 35 can pick-up the container 26 form the stack in the section 34 and load it onto a flatbed haulage truck 16 so that the container can be transported to the mineral processing plant or other location.

It can be appreciated that the above-described embodiment provides considerable flexibility for mine operators and can provide the above-described advantages.

The mining operation provides an opportunity to track payloads of mined material and processed mined material having a known mineralogy from a mine pit to a port. This provides an opportunity to minimise material handling, maximise available mined material and processed mined material to meet customer product requirements, minimise material handling to meet customer specifications, and minimise time from a mine pit to a ship. By way of example, the invention provides an opportunity to schedule railway operations from multiple mines to deliver more optimum mined material and processed mined material for meeting customer specifications to a port. A potential benefit is to minimise stockpiles of mined material and processed mined material at a port. The invention also provides an opportunity to provide a storage facility for containers of mined material and processed mined material at a port, with container identification and tracking from mine to port and at the port. Therefore, the invention provides an opportunity to minimise re-handling of mined material and processed mined material from a mine pit to a port. Mined material and processed mined material can be loaded into a container and transported in the container and unloaded at a mineral processing plant or at port. This is a significant difference to the current haul truck approach.

By way of summary, the mining operation includes the following features by way of example only and provides the following benefits:
1. Allows for easier change of transport media (e.g. from truck to truck, truck to/from train, stockpile to/from truck).
2. Allows different geared trucks for steep hauls, which provides an opportunity for quicker transport times.
3. Allows use of different transport mechanisms (e.g. a ski lift type haulage) for parts of a journey.
4. Allows for stockpiles (or others) to be built as stacks of containers.
5. Stockpiles can be managed like container ship harbour facility (e.g. using automated straddle carriers, gantries, etc.).
6. Re-handling of mined material and processed mined material (i.e. the transfer of mined material and processed mined material from one transport means to another, or to/from a transport means and a stockpile site) becomes easier with reduced (or outright elimination of) and dilution and loss.
7. Containers can be tracked with the properties (chemical, grade, fragmentation) of their payload over time for example by using RFID/block chain technology.
8. Improved storage of a payload and consequently increased preservation of transported material.
9. Improved resolution (and intelligence) of stockpiles (c.f. trucks with large trays) is achieved due to the fact that load after load of material is not constantly tipped onto stockpiles, which causes blending, mixing, etc.
10. Mined material and processed mined material can be tracked by container load and mapped via a digital twin. This allows for advance decision machining and improved blending into a processing plant (for high and low-grade stockpiles). The resolution is also improved by the use of smaller container sizes (e.g. 50 tonnes vs 200 tonnes), which is a viable option with the invention.
11. Avoids the need for haul trucks with rear-tipping trays and a tipping mechanism and/or hydraulics to unload a transported mined material and processed mined material.

Many modifications may be made to the embodiments of the invention described above without departing from the spirit and scope of the invention.

The embodiments are meant to be illustrative only and is not meant to be limiting to the invention.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may be in some appropriate cases. Furthermore, the particular features, structures or characteristics may be combined in any suitable manner, as would be apparent to one of ordinary skill in the art from this disclosure, in one or more embodiments.

In the description provided herein, numerous specific details are set forth. However, it is understood that embodiments of the invention may be practised without these specific details. In other instances, well-known methods, structures and techniques have not been shown in detail in order not to obscure an understanding of this description.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

1. A method of transporting a mined material, comprising:
determining that a first hauler is located at a material loading location of a mine;
controlling a plurality of loaders to load mined material into the first hauler, wherein the plurality of loaders are controlled such as to load into the first hauler mined material of a first material category only, and implementing dynamic control to ensure only one loader is interacting with the first hauler at a time;
in response to identifying that loading of the first hauler is complete, controlling the plurality of loaders to cease loading of the first hauler; and
communicating an instruction to the first hauler to move to a determined first unloading location for unloading of the loaded mined material,
wherein the first unloading location is determined, at least in part, according to the first material category of mined material loaded into the first hauler.

2. The method of claim 1, comprising:
determining that a second hauler is located at the material loading location of a mine during loading of the first hauler;
controlling the plurality of loaders to load mined material into the second hauler, wherein the plurality of loaders are controlled such as to load into the second hauler mined material of a second material category only, said second material category being different to the first material category, and implementing dynamic control to ensure only one loader is interacting with the second hauler at a time,
such that at least a portion of the loading of the first hauler by the plurality of loaders occurs during loading of the second hauler by the plurality of loaders.

3. The method of claim 2, comprising:
sensing material picked up by a particular loader to enable characterisation of picked up material to thereby assign a corresponding material category to the picked up material; and
directing the particular loader to load either the particular one of the first hauler and second hauler associated with the same material category of the picked up material.

4. The method of claim 2, comprising:
in response to identifying that loading of the second hauler is complete, controlling the plurality of loaders to cease loading of the second hauler; and
communicating an instruction to the second hauler to move to a determined second unloading location for unloading of the loaded mined material,
wherein the second unloading location is determined, at least in part, according to the second material category associated with the second hauler, wherein the second unloading location is distinct to the first unloading location.

5. The method of claim 1, wherein the first hauler is returned to the material loading location after unloading the loaded mined material and subsequently loaded with mined material of a different material category to the first material category.

6. A mine coordination system for coordinating loading of mined material at a material loading location of a mine into haulers, the system comprising:
a controller configured, in response to determining an arrival of a first hauler in a load-ready state at the material loading location, to:
control one or more loaders, via a data communication, to load mined material into the first hauler, wherein the one or more loaders are controlled such as to load into the first hauler mined material of a first material category only, wherein when two or more loaders are controlled to load the first hauler, the controller implementing dynamic control to ensure only one loader is interacting with the first hauler at a time;
identify that loading of the first hauler is complete;
in response, control the one or more loaders to cease loading of the first hauler; and
communicate an instruction to cause the first hauler to move to a determined first unloading location for unloading of the loaded mined material,
wherein the first unloading location is determined, at least in part, according to the first material category of mined material loaded into the first hauler.

7. The system of claim 6, wherein the controller is configured to:
upon determining that a second hauler is located at the material loading location during loading of the first hauler:
control the one or more loaders to load mined material into the second hauler, wherein the one or more loaders are controlled such as to load into the second hauler mined material of a second material category only, said second material category being different to the first material category, and implement dynamic control to ensure only one loader is interacting with the second hauler at a time,
such that at least a portion of the loading of the first hauler by the one or more loaders occurs during loading of the second hauler by the one or more loaders.

8. The system of claim 7, wherein at least one loader comprises a sensing device for sensing characteristics of material picked up by said loader to enable characterisation of picked up material, and wherein the controller is configured to:
when controlling a particular loader of said at least one loader to load mined material into a first loader and second loader:
determine a material category of a picked up load of material as corresponding to the first material category or the second material category; and
direct the particular loader to load either the particular one of the first hauler and second hauler associated with the same material category of the picked up material.

9. The system of claim 8, wherein the controller is configured to:
identify that loading of the second hauler is complete;
in response, control the one or more loaders to cease loading of the second hauler; and
communicate an instruction to cause the second hauler to move to a determined second unloading location for unloading of the loaded mined material,
wherein the second unloading location is determined, at least in part, according to the second material category of mined material loaded into the second hauler, wherein the second unloading location is distinct to the first unloading location.

10. The system of claim 6, wherein the first hauler is returned to the material loading location after unloading the loaded mined material and subsequently loaded with mined material of a different material category to the first material category.

11. A method of mining in a mine includes:
mining an area in the mine;
loading a mined material of a particular material category only into a container that is demountably located on a movable unit or demountably coupled to a moving unit, wherein the container is located at a first location in the mine, wherein said material category defines at least one property of the mined material;
tracking the material category of material loaded into the container such as to enable machine identification of said material category;
transporting the loaded container from the mining area on the movable unit or the moving unit to a second location in the mine; and
removing the loaded container from the movable unit or the moving unit at the second location and storing the loaded container at the second location.

12. The method of claim 11, wherein the second location is a container storage facility comprising two or more storage areas, each associated with a different material category, and wherein the loaded container is transported to a particular one of the storage areas in dependence on its assigned material category.

13. The method of claim 11, wherein the second location is a mineral processing plant in the mine, and wherein transporting the loaded container from the mining area on the movable unit or the moving unit to the mineral processing plant is in dependence on the material category associated with the container.

14. The method of claim 11, comprising:
controlling a container transport network such as to provide load-ready containers, as required, to the area in the mine, wherein the container transport network comprising a plurality of container transporters, wherein each container transporter is controllable to receive and move a selected container to a selected location and release the selected container at the selected location.

15. The method of claim 11, comprising:
tracking one or more statuses for each of a plurality of containers, each configured for receiving and storing mined material, thereby enabling identification of a particular container as being one of load-ready or loaded, wherein a load-ready container is presently suited to be loaded with a mined material and a loaded container is presently loaded with a mined material.

16. The method of claim 11, wherein each container comprises a machine-readable identifier for identifying a particular container, and wherein, for a loaded container, the material category associated with the loaded material is determinable by cross-referencing the machine-readable identifier to a record associated with the container.

17. The method of claim 11, comprising:
selecting a particular material category for loading into said container;
controlling at least one controllable loader at the location to load said container with mined material of said particular material category only.

18. A mine coordination system for coordinating loading of mined material at a material loading location of a mine into containers, comprising:
a controller configured to:
control loading of a mined material of a particular material category only into a container that is demountably located on a movable unit or demountably coupled to a moving unit, wherein the container is located at a first location in the mine, wherein said material category defines at least one property of the mined material;
maintain a record of the material category loaded into the container such as to enable machine identification of said material category;
control the movable unit or the moving unit to move the loaded container from the first location on to a second location in the mine for removal of the loaded container from the movable unit or the moving unit at the second location to thereby store the loaded container at the second location.

19. The system of claim 18, wherein the second location is a container storage facility comprising two or more storage areas, each associated with a different material category, and wherein the loaded container is transported to a particular one of the storage areas in dependence on its assigned material category.

20. The system of claim 18, wherein the second location is a mineral processing plant in the mine, and wherein the loaded container is moved from the first location on the movable unit or the moving unit to the mineral processing plant in dependence on the material category associated with the container.

21. The system of claim 18, wherein the controller is configured to:
control a container transport network such as to provide load-ready containers, as required, to the first location in the mine, wherein the container transport network comprises a plurality of container transporters, wherein each container transporter is controllable to receive and move a selected container to a selected location and release the selected container at the selected location.

22. The system of claim 18, wherein the controller is configured to:
maintain a container database for storing one or more statuses for each of a plurality of containers, each configured for receiving and storing mined material, thereby enabling identification of a particular container as being one of load-ready or loaded, wherein a load-ready container is presently suited to be loaded with a mined material and a loaded container is presently loaded with a mined material.

23. The system of claim 18, wherein each container comprises a machine-readable identifier for identifying a particular container, and wherein, for a loaded container, the material category associated with the loaded material is determinable by cross-referencing the machine-readable identifier to the record associated with the container.

24. The system of claim 18, wherein the controller is configured to:
select a material category for loading into said container;
control at least one controllable loader at the location to load said container with mined material of said selected material category only.
